(19) United States
(12) Patent Application Publication
(10) Pub. No.: US 2026/0300500 A1
(43) Pub. Date: Oct. 1, 2026

(54) Determining and Using Vulnerability Scores During Direct-to-Cell Satellite Coverage

(71) Applicants: AT&T Mobility II LLC, Atlanta, GA (US); AT&T Intellectual Property I, L.P., Atlanta, GA (US)

(72) Inventors: Nathan Stowell, Lake Stevens, WA (US); Zhengyi Zhou, Chappaqua, NY (US); Rashmi Palamadai, Naperville, IL (US); Yupeng Jia, South Pasadena, CA (US)

(73) Assignees: AT&T Mobility II LLC, Atlanta, GA (US); AT&T Intellectual Property I, L.P., Atlanta, GA (US)

(21) Appl. No.: 19/096,820

(22) Filed: Apr. 1, 2025

(51) Int. Cl. G06F 21/57

(52) U.S. Cl. CPC G06F 21/577; G06F 2221/034

(57) ABSTRACT

Determining and using vulnerability scored during direct-to-cell satellite coverage can include obtaining device data that can identify a user device, a current network connection of the user device, and a current location of the user device. Based on the device data, a vulnerability score can be calculated for the user device, the vulnerability score defining vulnerability of the user of the user device at the current location of the user device. A record for the user device can be updated with the vulnerability score, the current network connection of the user device, and the current location of the user device. Based on the record associated with the user device, it can be determined if the vulnerability score is actionable, and if so, an alert can be generated for a contact.

### BACKGROUND

Some modern computing devices such as smartphones, smartwatches, vehicle computing systems, and the like, can include multiple transceivers for conducting communications over one or more networks. At some times, tracking what network a device is communicating with can be complicated, and because network conditions can change rapidly, it may be difficult for a user to stay informed about current connections, connection statuses, and/or connection options at any given time.

### SUMMARY

The present disclosure is directed to determining and using vulnerability scores during direct-to-cell satellite coverage. A user device can be configured to execute a coverage management application that can monitor geographic location of the user device, biometric readings at biometric sensors of (or in communication with) the user device, historical usage information associated with the user device (e.g., locations at which the user device has been located, activity of the user device at various locations, combinations thereof, or the like), and other information. The user device can be configured to detect when a change in a network connection occurs at the user device such as, for example, the user device connects to a direct-to-cell satellite network connection provided by a direct-to-cell satellite network with no backup connection available. In response to detecting such a change in the network connection, the user device can be configured to create device data that can include identity data that identifies the user device and/or a user thereof, connection data that identifies a current network connection of the user device, contact data that identifies new or updated contacts designated for the user device, biometric data that includes biometric sensor readings for a user associated with the user device, historical usage data that defines historical usage information for the user device, and/or other data such as indications of whether any other devices are located in proximity to the user device (and if so how many), preferences, settings, or the like. The user device can also update a user interface based on detecting the change in the network connection at the user device. The user device can send the device data to a coverage management service hosted and/or executed by the server computer. It should be understood that this example embodiment is illustrative, and therefore should not be construed as being limiting in any way.

The server computer can analyze the device data and create and/or update a record in a user database that is maintained for the user device. The server computer can update the record, for example, to indicate the current network connection for the user device and a current vulnerability score for the user device. The vulnerability score can reflect a degree of vulnerability for the user device based on the device data and therefore can be based, in some embodiments, on location, familiarity of the user of the user device with the location, how many other devices are in proximity to the user device, geodata that defines crime statistics and/or demographics for the location, combinations thereof, or the like. The server computer can determine if the vulnerability score indicates a high vulnerability of the user device and, if so, can generate alerts and/or commands. It should be understood that this example embodiment is illustrative, and therefore should not be construed as being limiting in any way.

The server computer can generate alerts for the user device, the contact device, and/or the third party device. The alerts can indicate the high vulnerability condition at the user device and can include, in some embodiments, an indication of a current geographic location of the user device, options or instructions for reducing the vulnerability of the user device, and/or other information. The recipients of the alerts can be configured to present and/or update user interfaces based on the alerts, in various embodiments. The recipients of the alerts can also be configured to take various actions on the alerts, if desired, such as taking actions to reduce vulnerability of the user device (e.g., by the user device), contacting authorities to obtain assistance for the user device (e.g., by the contact device), assisting the user device (e.g., by the third party associated with the third party device), and the like. Actions taken by the user device can include navigating to a geographic location at which the connectivity is not as limited as the current network connection provided by the direct-to-cell satellite network, navigating to a location at which the familiarity of the user of the user device is higher than at the current location, navigating to a location at which emergency services respond quicker than at a current location, navigating to a location at which more other devices are located, combinations thereof, or the like. It should be understood that this example embodiment is illustrative, and therefore should not be construed as being limiting in any way.

The server computer also can generate the commands, which can include instructions for prioritizing communications associated with the user device. The server computer can send the commands to the direct-to-cell satellite network and/or a device thereof. The direct-to-cell network can be configured to prioritize communications of the user device on the direct-to-cell network in response to the command, thereby reducing vulnerability of the user device. It should be understood that this example embodiment is illustrative, and therefore should not be construed as being limiting in any way.

According to one aspect of the concepts and technologies disclosed herein, a system is disclosed. The system can include a processor and a memory. The memory can store computer-executable instructions that, when executed by the processor, cause the processor to perform operations. The operations can include obtaining device data associated with a user device. The device data can include identity data that can identify the user device, connection data that can identify a current network connection of the user device, and location data that can indicate a current location of the user device. The connection data can indicate that the user device currently has limited network connectivity and is connected to a direct-to-cell satellite network connection. The operations further can include calculating, based on the connection data and the location data, a vulnerability score for the user device, the vulnerability score defining a level of vulnerability of the user of the user device at the current location of the user device. The operations further can include obtaining a record associated with the user device, the record being stored in a user database; and updating the record with the vulnerability score, the current network connection of the user device, and the current location of the user device. An updated record can identify a contact that is to be updated if the vulnerability score indicates a high vulnerability for the user device when the user device has limited network connectivity and is connected to the direct-to-cell satellite network connection. The operations further can include determining, based on the record associated with the user device, if the vulnerability score is actionable; and in response to determining that the vulnerability score is actionable, generating an alert for the contact.

In some embodiments, the device data further can include historical usage data, and the vulnerability score can be calculated based on the connection data, the location data, and the historical usage data. The historical usage data and the location data can be analyzed to determine a familiarity of the user of the user device with the current location of the user device. In some embodiments, the device data further can include contact information, and the alert that is generated for the contact can include an indication that the user device is in a high vulnerability situation and data identifying the current location of the user device. In some embodiments, the operations can further include generating a further alert for the user device. The further alert can include instructions for reducing the vulnerability score associated with the user device, the instructions including instructions for navigating to a new location, and the user device updating a user interface at the user device based on the further alert.

In some embodiments, the new location can include a further geographic location at which the user device can connect to a network connection other than the direct-to-cell satellite network connection, at which emergency services can respond quicker than at the current location of the user device, and at which the user device has operated more frequently than at the current location of the user device. In some embodiments, operations can further include determining, based on the vulnerability score, that communications associated with the user device should be prioritized by the direct-to-cell satellite network; generating a command that, when received by a device operating on the direct-to-cell satellite network, causes the direct-to-cell satellite network to prioritize the communications associated with the user device; and sending, to the device operating on the direct-to-cell satellite network, the command. In some embodiments, the operations can further include in response to determining, based on the vulnerability score and the record, that third party access to the record is to be enabled, enabling access to the record associated with the user device by a third party device. The third party device can include a computer device associated with an emergency responder.

According to another aspect of the concepts and technologies disclosed herein, a method is disclosed. The method can include obtaining, at a server computer including a processor, device data associated with a user device. The device data can include identity data that can identify the user device, connection data that can identify a current network connection of the user device, and location data that can indicate a current location of the user device. The connection data can indicate that the user device currently has limited network connectivity and is connected to a direct-to-cell satellite network connection. The method further can include calculating, by the processor and based on the connection data and the location data, a vulnerability score for the user device, the vulnerability score defining a level of vulnerability of the user of the user device at the current location of the user device. The method further can include obtaining, by the processor, a record associated with the user device, the record being stored in a user database; and updating, by the processor, the record with the vulnerability score, the current network connection of the user device, and the current location of the user device. An updated record can identify a contact that is to be updated if the vulnerability score indicates a high vulnerability for the user device when the user device has limited network connectivity and is connected to the direct-to-cell satellite network connection. The method further can include determining, by the processor and based on the record associated with the user device, if the vulnerability score is actionable; and in response to determining that the vulnerability score is actionable, generating, by the processor, an alert for the contact.

In some embodiments, the device data further can include historical usage data, and the vulnerability score can be calculated based on the connection data, the location data, and the historical usage data. The historical usage data and the location data can be analyzed to determine a familiarity of the user of the user device with the current location of the user device. In some embodiments, the device data further can include contact information, and the alert that is generated for the contact can include an indication that the user device is in a high vulnerability situation and data identifying the current location of the user device. In some embodiments, the method can further include generating a further alert for the user device. The further alert can include instructions for reducing the vulnerability score associated with the user device, the instructions including instructions for navigating to a new location, and the user device updating a user interface at the user device based on the further alert.

In some embodiments, the new location can include a further geographic location at which the user device can connect to a network connection other than the direct-to-cell satellite network connection, at which emergency services can respond quicker than at the current location of the user device, and at which the user device has operated more frequently than at the current location of the user device. In some embodiments, the method can further include determining, based on the vulnerability score, that communications associated with the user device should be prioritized by the direct-to-cell satellite network; generating a command that, when received by a device operating on the direct-to-cell satellite network, causes the direct-to-cell satellite network to prioritize the communications associated with the user device; and sending, to the device operating on the direct-to-cell satellite network, the command. In some embodiments, the method can further include in response to determining, based on the vulnerability score and the record, that third party access to the record is to be enabled, enabling access to the record associated with the user device by a third party device. The third party device can include a computer device associated with an emergency responder.

According to yet another aspect of the concepts and technologies disclosed herein, a computer storage medium is disclosed. The computer storage medium can store computer-executable instructions that, when executed by a processor, cause the processor to perform operations. The operations can include obtaining device data associated with a user device. The device data can include identity data that can identify the user device, connection data that can identify a current network connection of the user device, and location data that can indicate a current location of the user device. The connection data can indicate that the user device currently has limited network connectivity and is connected to a direct-to-cell satellite network connection. The operations further can include calculating, based on the connection data and the location data, a vulnerability score for the user device, the vulnerability score defining a level of vulnerability of the user of the user device at the current location of the user device. The operations further can include obtaining a record associated with the user device, the record being stored in a user database; and updating the record with the vulnerability score, the current network connection of the user device, and the current location of the user device. An updated record can identify a contact that is to be updated if the vulnerability score indicates a high vulnerability for the user device when the user device has limited network connectivity and is connected to the direct-to-cell satellite network connection. The operations further can include determining, based on the record associated with the user device, if the vulnerability score is actionable; and in response to determining that the vulnerability score is actionable, generating an alert for the contact.

In some embodiments, the device data further can include historical usage data, and the vulnerability score can be calculated based on the connection data, the location data, and the historical usage data. The historical usage data and the location data can be analyzed to determine a familiarity of the user of the user device with the current location of the user device. In some embodiments, the device data further can include contact information, and the alert that is generated for the contact can include an indication that the user device is in a high vulnerability situation and data identifying the current location of the user device. In some embodiments, the operations can further include generating a further alert for the user device. The further alert can include instructions for reducing the vulnerability score associated with the user device, the instructions including instructions for navigating to a new location, and the user device updating a user interface at the user device based on the further alert.

In some embodiments, the new location can include a further geographic location at which the user device can connect to a network connection other than the direct-to-cell satellite network connection, at which emergency services can respond quicker than at the current location of the user device, and at which the user device has operated more frequently than at the current location of the user device. In some embodiments, operations can further include determining, based on the vulnerability score, that communications associated with the user device should be prioritized by the direct-to-cell satellite network; generating a command that, when received by a device operating on the direct-to-cell satellite network, causes the direct-to-cell satellite network to prioritize the communications associated with the user device; and sending, to the device operating on the direct-to-cell satellite network, the command. In some embodiments, the operations can further include in response to determining, based on the vulnerability score and the record, that third party access to the record is to be enabled, enabling access to the record associated with the user device by a third party device. The third party device can include a computer device associated with an emergency responder.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a flow diagram showing aspects of a method for obtaining and presenting a vulnerability score during direct-to-cell satellite coverage, according to an illustrative embodiment of the concepts and technologies described herein.

FIG. 3 is a flow diagram showing aspects of a method for computing and using a vulnerability score during direct-to-cell satellite coverage, according to an illustrative embodiment of the concepts and technologies described herein.

FIG. 4 is a flow diagram showing aspects of a method for generating alerts and commands based on vulnerability scores during direct-to-cell satellite coverage, according to an illustrative embodiment of the concepts and technologies described herein.

FIGS. 5A-5B are user interface diagrams showing various screen displays for providing, determining, and using vulnerability scores during direct-to-cell satellite coverage, according to some illustrative embodiments of the concepts and technologies described herein.

FIG. 6 schematically illustrates a network, according to an illustrative embodiment of the concepts and technologies described herein.

FIG. 7 is a block diagram illustrating an example computer system configured to determine and use vulnerability scores during direct-to-cell satellite coverage, according to some illustrative embodiments of the concepts and technologies described herein.

FIG. 8 is a block diagram illustrating an example mobile device configured to interact with a coverage management service, according to some illustrative embodiments of the concepts and technologies described herein.

FIG. 9 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to determining and using vulnerability scores during direct-to-cell satellite coverage. A user device can be configured to execute a coverage management application that can monitor geographic location of the user device, biometric readings at biometric sensors of (or in communication with) the user device, historical usage information associated with the user device (e.g., locations at which the user device has been located, activity of the user device at various locations, combinations thereof, or the like), and other information. The user device can be configured to detect when a change in a network connection occurs at the user device such as, for example, the user device connects to a direct-to-cell satellite network connection provided by a direct-to-cell satellite network with no backup connection available. In response to detecting such a change in the network connection, the user device can be configured to create device data that can include identity data that identifies the user device and/or a user thereof, connection data that identifies a current network connection of the user device, contact data that identifies new or updated contacts designated for the user device, biometric data that includes biometric sensor readings for a user associated with the user device, historical usage data that defines historical usage information for the user device, and/or other data such as indications of whether any other devices are located in proximity to the user device (and if so how many), preferences, settings, or the like. The user device can also update a user interface based on detecting the change in the network connection at the user device. The user device can send the device data to a coverage management service hosted and/or executed by the server computer. It should be understood that this example embodiment is illustrative, and therefore should not be construed as being limiting in any way.

The server computer can analyze the device data and create and/or update a record in a user database that is maintained for the user device. The server computer can update the record, for example, to indicate the current network connection for the user device and a current vulnerability score for the user device. The vulnerability score can reflect a degree of vulnerability for the user device based on the device data and therefore can be based, in some embodiments, on location, familiarity of the user of the user device with the location, how many other devices are in proximity to the user device, geodata that defines crime statistics and/or demographics for the location, combinations thereof, or the like. The server computer can determine if the vulnerability score indicates a high vulnerability of the user device and, if so, can generate alerts and/or commands. It should be understood that this example embodiment is illustrative, and therefore should not be construed as being limiting in any way.

The server computer can generate alerts for the user device, the contact device, and/or the third party device. The alerts can indicate the high vulnerability condition at the user device and can include, in some embodiments, an indication of a current geographic location of the user device, options or instructions for reducing the vulnerability of the user device, and/or other information. The recipients of the alerts can be configured to present and/or update user interfaces based on the alerts, in various embodiments. The recipients of the alerts can also be configured to take various actions on the alerts, if desired, such as taking actions to reduce vulnerability of the user device (e.g., by the user device), contacting authorities to obtain assistance for the user device (e.g., by the contact device), assisting the user device (e.g., by the third party associated with the third party device), and the like. Actions taken by the user device can include navigating to a geographic location at which the connectivity is not as limited as the current network connection provided by the direct-to-cell satellite network, navigating to a location at which the familiarity of the user of the user device is higher than at the current location, navigating to a location at which emergency services respond quicker than at a current location, navigating to a location at which more other devices are located, combinations thereof, or the like. It should be understood that this example embodiment is illustrative, and therefore should not be construed as being limiting in any way.

The server computer also can generate the commands, which can include instructions for prioritizing communications associated with the user device. The server computer can send the commands to the direct-to-cell satellite network and/or a device thereof. The direct-to-cell network can be configured to prioritize communications of the user device on the direct-to-cell network in response to the command, thereby reducing vulnerability of the user device. It should be understood that this example embodiment is illustrative, and therefore should not be construed as being limiting in any way.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

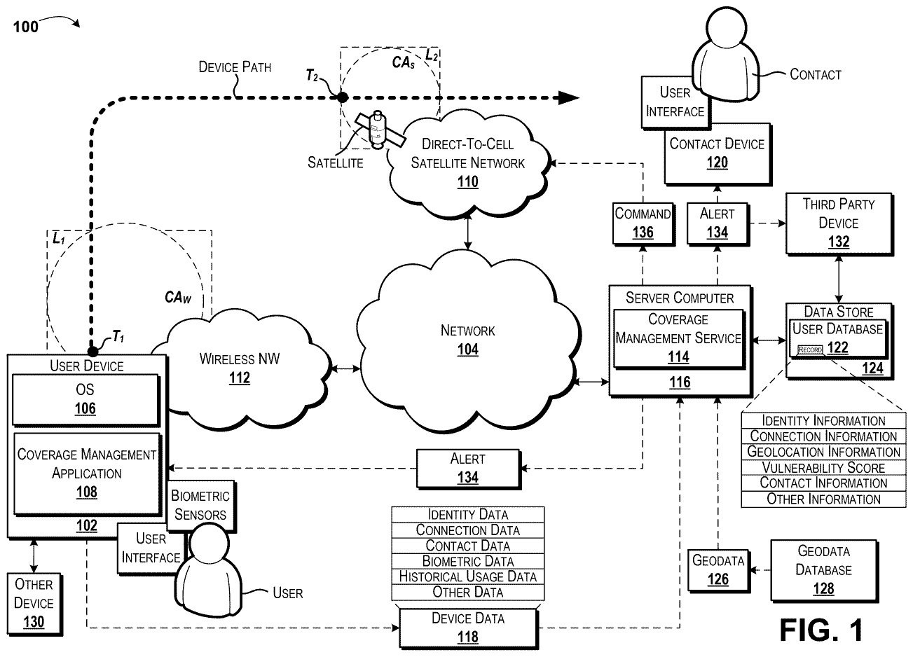

Referring now to FIG. 1, aspects of an operating environment 100 for various embodiments of the concepts and technologies disclosed herein for determining and using vulnerability scores during direct-to-cell satellite coverage will be described, according to an illustrative embodiment. The operating environment 100 shown in FIG. 1 includes a user device 102. The user device 102 can operate in communication with and/or as part of one or more communications networks such as, for example, a communications network (“network”) 104, though this is not necessarily the case in all embodiments. As will be further explained herein, the network 104 can be accessed in various embodiments by one or more other networks, subnetworks, portals, or the like. Similarly, the user device 102 may connect to the network 104 directly, through or via these other networks, subnetworks, portals, or the like in various embodiments. These and other aspects of the operating environment 100 will be explained in more detail hereinbelow after introducing the various components of the operating environment 100.

According to various embodiments, the functionality of the user device 102 may be provided by one or more mobile telephones or smartphones, laptop computers, tablet computers, vehicle computing systems, other computing systems, and the like. It should be understood that the functionality of the user device 102 may be provided by a single device, by two or more similar devices, and/or by two or more dissimilar devices. For purposes of describing the concepts and technologies disclosed herein, the user device 102 is described herein as a smartphone. It should be understood that this embodiment is illustrative, and should not be construed as being limiting in any way.

The user device 102 can be configured to execute an operating system 106 and one or more application programs such as, for example, a coverage management application 108. The operating system 106 can include a computer program that can control the operation of the user device 102. The coverage management application 108 can include an executable program that can be configured to execute on top of the operating system 106 to provide various functions as illustrated and described herein for determining and using vulnerability scores during direct-to-cell satellite coverage as illustrated and described herein.

In various embodiments, the coverage management application 108 can be configured to detect one or more network connections of the user device 102; to update one or more entities regarding the one or more network connections of the user device 102 (as will be illustrated and described herein in more detail below); to receive one or more notifications or other communications and update user interfaces based on those communications; combinations thereof; or the like. These and/or other functions of the coverage management application 108 will be illustrated and described herein after introducing additional entities operating in and/or associated with the operating environment 100.

In the illustrated embodiment shown in FIG. 1, the user device 102 can be configured to communicate with the network 104 directly and/or through a direct-to-cell satellite network 110; a cellular network and/or other wireless network such as a WiFi network (hereinafter referred to as a “wireless network”) 112; a vehicle-to-vehicle or other peer-to-peer network; other networks; combinations thereof; or the like. As is generally understood, capabilities (e.g., bandwidth, latency, upload speed, download speed, etc.) of network connections associated these networks, subnetworks, and/or other networking connections such as, for example, the network 104, the direct-to-cell satellite network 110, the wireless network 112, or the like, can vary. For example, capabilities of these and/or other connections may vary based on time and/or proximity of the user device 102 to hardware associated with these connections, limitations of hardware that provides these connections, and/or based on other factors. According to various embodiments of the concepts and technologies disclosed herein, the coverage management application 108 can be configured to create, update, and use information that indicates how the user device 102 is connected to one or more of these networks, and to provide this information to other entities for purposes of determining a vulnerability (e.g., of a user) at the user device 102 and/or to take various actions based on the determined vulnerability. These and other functions of the coverage management application 108 will be illustrated and described herein in more detail.

According to various embodiments, the user device 102 can connect to one or more networks and/or subnetworks at various times. As shown in the illustrated example embodiment shown in FIG. 1, the user device 102 can connect to the wireless network 112 at a first time T₁ and while located at or in proximity to a first area or geographic location (hereinafter first location L₁) such as a home, a business, a vehicle, or the like. In some embodiments, the user device 102 can be configured to access the network 104 and/or other networks via the wireless network 112 at various times and/or locations including, but not limited to, the first time T₁ while at or near the first location L₁. In various embodiments, as illustrated in FIG. 1, the wireless network 112 can have an associated wireless network coverage area CA_{W} that can correspond to a communication range in which the user device 102 can communicate with the wireless network 112 and/or hardware thereof such as a radio unit (“RU”), a WiFi router or gateway, or the like. In various embodiments of the concepts and technologies disclosed herein, the wireless network coverage area CA_{W} can partially and/or completely overlap and/or can be encompassed within the boundaries of the first location L₁, though this is not necessarily the first location L₁, though this is not necessarily the case in all embodiments. As such, it should be understood that this example embodiment is illustrative, and therefore should not be construed as being limiting in any way.

The user device 102 also can be configured to access the wireless network 112 (e.g., a cellular network or the like) using cellular technology as is generally understood. For example, the user device 102 can be configured to communicate with the wireless network 112 to negotiate a connection and/or to be provisioned with cellular network connectivity using a cellular transceiver and/or other functionality as is generally understood. It should also be noted that the user device 102 also can be configured to connect to the direct-to-cell satellite network 110 using a cellular transceiver and/or other hardware of the user device 102, or using dedicated hardware in some embodiments. It should be understood that this example embodiment is illustrative, and therefore should not be construed as being limiting in any way.

According to various embodiments of the concepts and technologies disclosed herein, the coverage management application 108 can be configured to detect one or more network connections between the user device 102 and the one or more of the networks 104, 110, 112; to communicate with other entities relating to the one or more network connections of the user device 102; to create and/or update user interfaces at the user device 102 to reflect current and/or future network connections and/or other information as illustrated and described herein; to perform other functions; combinations thereof; or the like. In various embodiments, for example, the coverage management application 108 can be configured to monitor one or more transceivers and/or other hardware of the user device 102 (e.g., a WiFi transceiver, a Bluetooth transceiver, a cellular transceiver, a physical connection port, or the like) to determine and/or identify one or more network connections currently available to and/or active at the user device 102. Because this information can be obtained by the coverage management application 108 in additional and/or alternative manners (e.g., reporting mechanisms, or the like), it should be understood that this example embodiment is illustrative, and therefore should not be construed as being limiting in any way. The coverage management application 108 also can be configured to report the connections of the user device 102 to one or more other entities, as will be explained in more detail herein.

In particular, as shown in FIG. 1, the user device 102 can be configured (e.g., via execution of the coverage management application 108) to communicate with a coverage management service 114. The functionality of the coverage management service 114 can be provided by an application, program, module, service, or the like; which can be hosted and/or executed by a computing device such as a server computer 116. In various embodiments, the functionality of the server computer 116 can be provided by an application server, a web server, or the like. The functionality of the server computer 116 may be provided by a single device, by two or more similar devices, and/or by two or more dissimilar devices (e.g., by a single server computer, by a cloud-based server computer, by one or more virtual resources, or the like). For purposes of describing the concepts and technologies disclosed herein, the server computer 116 is described herein as an application server that can host and/or execute the coverage management service 114. It should be understood that this example embodiment is illustrative, and therefore should not be construed as being limiting in any way.

In various embodiments of the concepts and technologies disclosed herein, the coverage management service 114 can determine what connection(s) are active at the user device 102 based on device data 118, which can be generated by the user device 102 and obtained by the coverage management service 114 from the user device 102 at various times. The device data 118 will be explained in more detail below. In some other embodiments, the coverage management service 114 can be configured to obtain information associated with the networks 104, 110, 112 from network monitors, network controls, reporting mechanisms, combinations thereof, or the like instead of obtaining the device data 118. As such, it should be understood that the illustrated embodiment is illustrative and therefore should not be construed as being limiting in any way. Based on the device data 118 or other information obtained by the coverage management service 114, the coverage management service 114 can be configured to identify one or more networks and/or network resources connected to by the user device 102 at any particular time. It should be understood that this example embodiment is illustrative, and therefore should not be construed as being limiting in any way.

As shown in FIG. 1, the user device 102 may not be stationary and may move along a device path at some times. In particular, the user device 102 may move (or be moved) along the device path. The user device 102 can enter and/or be located at the first location L₁ (and can be within a wireless network coverage area CA_{W}) at the first time T₁. The user device 102 can depart from the first location L₁ (and the wireless network coverage area CA_{W}) at some time and may move along the device path. The user device 102 may enter and/or may be located at the second location L₂ (and within a satellite coverage area CA_{S} of a satellite of the direct-to-cell satellite network 110) at a second time T₂. Thus, it can be appreciated from the example embodiment that the user device 102 may connect to the wireless network 112 at a first time T₁ and the direct-to-cell satellite network 110 at a second time T₂. It should be understood that this example embodiment is illustrative, and therefore should not be construed as being limiting in any way.

Connection information associated with the user device 102 (e.g., information identifying what network the user device 102 is connected to at a particular time, connection parameters, and the like) can be collected by the coverage management application 108 and reported to the coverage management service 114 as part of the device data 118. The reporting of the device data 118 by the user device 102 can occur in real-time (e.g., as connections change), proactively (e.g., before the connections change), at other times, combinations thereof, or the like. According to various embodiments of the concepts and technologies disclosed herein, the device data 118 can include, but is not limited to, identity data, connection data, contact data, biometric data, historical usage data, and/or other data, any and/or all of which may be associated with the user device 102. It should be understood that this example embodiment is illustrative, and therefore should not be construed as being limiting in any way.

According to various embodiments of the concepts and technologies disclosed herein, the identity data can identify the device itself (e.g., the user device 102) and/or a user thereof. Thus, for example, the identity data can include, but is not limited to, a device identifier such as an International Mobile Subscriber Identity (“IMSI”), an International Mobile Equipment Identity (“IMEI”), a Permanent Equipment Identifier (“PEI”), a media access control identifier (“MAC ID”), a serial number, an Internet protocol (“IP”) address, a web identifier (“WebID”), additional and/or alternative device identifiers, combinations thereof, or the like. The identity data also can identify a user of the device (e.g., the user device 102) such as a login, name, email address, a phone number, a unique identifier, combinations thereof, or the like. Because other information can identify devices (e.g., the user device 102) and/or users thereof, it should be understood that these example embodiments are illustrative, and therefore should not be construed as being limiting in any way.

The connection data can identify, for the user device 102, one or more networks or network connections to and/or with which the device (e.g., the user device 102) is connected and/or communicates. In various embodiments of the concepts and technologies disclosed herein, the user device 102 can capture connection information by, for example, monitoring activity of one or more transceivers of the user device 102, with an active transceiver indicating that a network connection exists and/or is being used. In some embodiments, the connection data can be obtained from other entities by the user device 102 (e.g., from a network reporting device, etc.). In any case, it can be appreciated that the coverage management application 108 can be configured to collect and report the device data 118 to the coverage management service 114 in various embodiments. It should be understood that this example embodiment is illustrative, and therefore should not be construed as being limiting in any way.

The contact data can identify, for example, one or more contacts for the user device 102. As shown in FIG. 1, a contact can be associated with a contact device 120. According to various embodiments, the functionality of the contact device 120 may be provided by one or more mobile telephones smartphones, laptop computers, tablet computers, vehicle computing systems, other computing systems, and the like. It should be understood that the functionality of the contact device 120 may be provided by a single device, by two or more similar devices, and/or by two or more dissimilar devices. For purposes of describing the concepts and technologies disclosed herein, the contact device 120 is described herein as a smartphone. The contact device 120 can operate on and/or in communication with the network 104, though this is not necessarily the case in all embodiments. The contact device 120 can also be configured to communicate with the network 104 and/or other networks via the wireless network 112, the direct-to-cell satellite network 110, other networks, combinations thereof, or the like. It should be understood that this embodiment is illustrative, and should not be construed as being limiting in any way.

As will be illustrated and described in more detail herein, embodiments of the concepts and technologies disclosed herein can enable a user or other entity associated with the user device 102 to designate one or more contacts (e.g., people, devices, or entities) that are to be updated at certain times, for example based on vulnerability scores, connectivity status, or the like associated with the user device 102. Because contacts can be updated at additional and/or alternative times, it should be understood that this example embodiment is illustrative, and therefore should not be construed as being limiting in any way. The contact data can identify the contacts by, for example, device identifiers and/or personal identifiers such as, for example, one or more IMSI, IMEI, PEI, MAC ID, IP address, WebID, name, telephone number, email address, login, other identifier, combinations thereof, or the like. As such, the contact data can include various identifiers as set forth above, as contact identifiers for contacts of the user device 102; one or more contact notification preferences and/or settings for the contacts of the user device 102; combinations thereof; or the like. It should be understood that this example embodiment is illustrative, and therefore should not be construed as being limiting in any way.

The biometric data can include, but is not limited to, biometric information captured by the user device 102 and/or biometric sensors thereof and/or in communication therewith. As such, the biometric data can include, for example, a heart rate of a user of the user device 102; a fingerprint, face, retina, or other identifying physical characteristic of a user of the user device 102; a heart rate, blood pressure, body temperature, oxygen saturation, or other condition associated with a user of the user device 102; facial expressions associated with a user of the user device 102; combinations thereof; or the like. Thus, it can be appreciated that the biometric sensors illustrated in FIG. 1 can include, but are not limited to, one or more thermometer or other temperature sensor, pulse oximeter, sphygmomanometer, camera or other imaging device, electrode, combinations thereof, or the like. Because other biometric data may be illustrated and described herein, it should be understood that these example embodiments are illustrative, and therefore should not be construed as being limiting in any way.

The historical usage data can include, but is not limited to, historical usage data associated with the user device 102 and/or various network connections; time and location records for the user device 102 (e.g., times at which the user device 102 was located at various geographic locations); application and/or process execution histories; combinations thereof; or the like. Thus, the historical usage data can be used to determine if a user device 102 and/or a user thereof is likely to be familiar with a particular environment and/or geographical location. Because other historical usage data may be illustrated and described herein, it should be understood that these example embodiments are illustrative, and therefore should not be construed as being limiting in any way.

The other data can include, for example, contextual information obtained from the user device 102 and/or applications or services used by and/or accessed by the user device 102; information identifying one or more other users or devices in an immediate proximity of the user device 102; content download preferences and/or rules for the user device 102 and/or one or more users or other parties or entities associated therewith; preferences and/or settings associated with the user device 102; location data such as a current or expected geographic location associated with the user device 102; motion data that can define motion and/or movements of the user device 102; or the like. It can be appreciated that the other data can include other information that can be used in some embodiments to project a location of the user device 102 at some time in the future and/or for other purposes. It should be understood that these example embodiments are illustrative, and therefore should not be construed as being limiting in any way.

Based on the device data 118 and/or other information such as default settings or configurations, the coverage management service 114 can be configured to create, update, maintain, and/or modify a user profile or record (hereinafter “record”) for the user device 102. According to various embodiments of the concepts and technologies disclosed herein, the record can be stored with records for other devices and/or users in and/or as a user database 122. According to various embodiments of the concepts and technologies disclosed herein, the user database 122 can be stored and/or hosted at a data store 124. The functionality of the data store 124 can be provided by one or more databases, server computers, data storage and/or host resources, other computing systems, and the like. In the illustrated embodiments, the data store 124 can be provided by a data server. In some embodiments, the data store 124 can correspond to a home subscriber server (“HSS”) and/or the like (e.g., a unified data management (“UDM”) and unified data repository (“UDR”)). It should be understood that this example embodiment is illustrative, and therefore should not be construed as being limiting in any way.

A record of the user database 122 can include, for example, identity information (e.g., a device identifier and/or user identifier) for a particular user or device (e.g., the user device 102 and/or a user thereof); connection information, which can represent or identify one or more active network connections for a device associated with the record (e.g., the user device 102); geolocation information (e.g., a current geographic location of the user device 102, a last known geographic location of the user device 102, or the like); a vulnerability score for the user device 102 (the vulnerability score and the calculation thereof will be explained in more detail herein); contact information for the user device 102 (e.g., device identifiers for contact devices 120 of contacts associated with the user device 102, alerting and/or communication preferences for the contacts and/or contact devices 120, or the like); other information; combinations thereof; or the like. It can be appreciated that the user database 122 can include records for one or more or even all users associated with a particular network (e.g., the network 104, the direct-to-cell satellite network 110, the wireless network 112, or the like). It should be understood that this example embodiment is illustrative, and therefore should not be construed as being limiting in any way.

According to various embodiments of the concepts and technologies disclosed herein, the user database 122 can be created and updated by the coverage management service 114. The user database 122 also can be accessed by the coverage management service 114 at various times, for example when a release of device data 118 is received (e.g., to update the record, or the like). In particular, according to various embodiments of the concepts and technologies disclosed herein, the coverage management service 114 can be configured to determine, for a device such as the user device 102, one or more network connections that is available to the user device 102 at some time. Based on this information, the coverage management service 114 can be configured to take various steps such as, for example, creating and/or updating a vulnerability score associated with the user device 102, updating contacts and/or third parties regarding the vulnerability score, managing prioritization of traffic associated with the user device 102 based on the vulnerability score, combinations thereof, or the like. These and other functions of the coverage management service 114 will be illustrated and described in more detail hereinbelow.

According to various embodiments of the concepts and technologies disclosed herein, the coverage management service 114 can be configured to receive or otherwise obtain device data 118 from the user device 102. It can be appreciated that the device data 118 can be provided to the server computer 116 at various times. In some embodiments, for example, the user device 102 can provide the device data 118 to the server computer 116 when a network connection of the user device 102 changes (e.g., from one network to another, to one network without a backup connection to the same network with a backup connection, to one network with a backup connection to the same network without a backup connection, from a prioritized connection to a non-prioritized connection, from two or more network connections to one or more network connections, and the like). Because other changes in network connectivity are possible and are contemplated, it should be understood that these example embodiments are illustrative, and therefore should not be construed as being limiting in any way. In some other embodiments, the user device 102 may provide the device data 118 to the server computer 116 at regular or irregular time intervals. In yet other embodiments, the user device 102 can provide the device data 118 to the server computer 116 when requested by the server computer 116 or another device or entity. In still other embodiments, the user device 102 can provide the device data 118 to the server computer 116 when a user or other entity of the user device 102 enters a command or option to provide the device data 118 to the server computer 116. Because the user device 102 can provide the device data 118 at additional and/or alternative times, it should be understood that these example embodiments are illustrative, and therefore should not be construed as being limiting in any way.

In some embodiments, the server computer 116 can be configured (e.g., via execution of the coverage management service 114) to analyze the device data 118 to determine an identity associated with the device data 118 (e.g., a user, device, or the like such as the user device 102 and/or a user associated therewith); to determine connection information for the user device 102 such as a current network status of the user device 102 (e.g., what network the user device 102 is currently connected to); to identify one or more contacts defined for the user device 102 and/or contact devices 120 of the contacts; to determine biometric readings captured at the user device 102 (e.g., from a user thereof); to identify and/or access historical usage information associated with the user device 102 (e.g., locations visited by the user device 102, activities at the locations visited by the user device 102, and the like); combinations thereof; or the like. The coverage management service 114 can use these and/or other types of information included in the device data 118 to create, store, and/or update a record associated with the user device 102, and/or to use the updated record and/or data thereof (e.g., the vulnerability score) to take various actions (e.g., to make the record and/or data thereof available to contacts or third parties, to prioritize traffic associated with the user device 102, combinations thereof, or the like). It should be understood that this example embodiment is illustrative, and therefore should not be construed as being limiting in any way.

In some embodiments, the server computer 116 can be configured (e.g., via execution of the coverage management service 114) to use the records (after the records have been created) upon receiving an instance of device data 118. In particular, upon receiving a release or instance of device data 118, the server computer 116 can determine an identity associated with the device data 118 and retrieve a record associated with the identity. By analyzing the record and the device data 118, the server computer 116 can determine a current network connection for the user device 102, biometric readings captured at the user device 102 (if included in the device data 118), and the like. The server computer 116 can be configured to update the record with the current network connection for the user device 102 and determine, based on the device data 118, if the user device 102 is currently connected to a satellite associated with the direct-to-cell satellite network 110. In some embodiments, connectivity provided to the user device 102 by the direct-to-cell satellite network 110 may be limited in terms of latency, bandwidth, other functionality, and the like. Thus, the server computer 116 can be configured to determine if the user device 102 is connected to the direct-to-cell satellite network 110 for purposes of performing various operations based on the user device 102 being expected to have limited connectivity in these situations. It should be understood that this example embodiment is illustrative, and therefore should not be construed as being limiting in any way.

If the server computer 116 determines that the user device 102 is currently connected to the direct-to-cell satellite network 110, the server computer 116 can analyze other information included in the device data 118 to update the record. The record can be updated to indicate the current connection determined for the user device 102; a current geographic location of the user device 102; zero, one, or more than one contact for the user device 102; contact preferences for the contacts of the user device 102; update preferences for third party entities; a vulnerability score of the user device 102; and the like. According to various embodiments of the concepts and technologies disclosed herein, the server computer 116 can determine at least the vulnerability score for the user device 102. It should be understood that this example embodiment is illustrative, and therefore should not be construed as being limiting in any way.

According to various embodiments of the concepts and technologies disclosed herein, the vulnerability score can reflect a vulnerability defined for the user device 102 based on the current connection of the user device 102, a current location of the user device 102, and a history of usage of the user device 102 at the current location of the user device 102. Thus, in various embodiments of the concepts and technologies disclosed herein, the vulnerability score can be calculated based on three factors, namely a location factor, a familiarity factor, and a connectivity factor. In some embodiments, these three factors can be weighted equally (e.g., one third of the vulnerability score can be based on each of these three factors) while in some other embodiments, the factors may be weighted differently. It should be understood that this example embodiment is illustrative, and therefore should not be construed as being limiting in any way.

In one example embodiment, if the user device 102 can be located at a first geographic location at which help is available quickly upon request (e.g., police, fire, and/or other first responders are expected to arrive at a call within a defined time period such as five minutes), the location factor can be assigned a score of high. If the geographic location corresponds to a location at which the user device 102 is frequently located, the server computer 116 can determine that the user associated with the user device 102 is expected to be familiar (and comfortable) with the surroundings of the user device 102, and the server computer 116 can be configured in this example to assign a high score to the familiarity factor used to generate the vulnerability score. Finally, if the user device 102 is connected to a high-speed connection such as a cellular connection provided by the wireless network 112, the server computer 116 can be configured to determine that seeking help and/or communicating with others may be quick and/or easy, and may therefore assign a high value to the connectivity factor. In weighing these factors, the server computer 116 can determine a vulnerability score (which can depend greatly in some cases upon weighting as mentioned herein). In this example, the vulnerability score may be indicated as indicating a low vulnerability. It should be understood that the vulnerability score can be designed such that a high numerical value corresponds to a low vulnerability, that a low numerical score corresponds to a low vulnerability, that non-numeric scales are used, or the like. It should be understood that this example embodiment is illustrative, and therefore should not be construed as being limiting in any way.

In another example embodiment, if the user device 102 can be located at a second geographic location at which help is not available quickly upon request (e.g., police, fire, and/or other first responders are expected to arrive at a call within a defined time period such as ten minutes), the location factor can be assigned a score of medium. If the geographic location corresponds to a location at which the user device 102 is not frequently located, the server computer 116 can determine that the user associated with the user device 102 is expected to be somewhat familiar (and somewhat comfortable) with the surroundings of the user device 102, and the server computer 116 can be configured in this example to assign a medium score to the familiarity factor used to generate the vulnerability score. Finally, if the user device 102 is connected to a high-speed connection such as a cellular connection provided by the wireless network 112, the server computer 116 can be configured to determine that seeking help and/or communicating with others may be quick and/or easy, and may therefore assign a high value to the connectivity factor. In weighing these factors, the server computer 116 can determine a vulnerability score (which can depend greatly in some cases upon weighting as mentioned herein). In this example, the vulnerability score may be indicated as indicating a medium vulnerability. It should be understood that this example embodiment is illustrative, and therefore should not be construed as being limiting in any way.

In yet another example embodiment, if the user device 102 can be located at a third geographic location at which help is not available quickly upon request (e.g., police, fire, and/or other first responders are expected to arrive at a call within a defined time period such as thirty minutes), the location factor can be assigned a score of low. If the geographic location corresponds to a location at which the user device 102 has never been located, the server computer 116 can determine that the user associated with the user device 102 is expected to be unfamiliar (and somewhat uncomfortable) with the surroundings of the user device 102, and the server computer 116 can be configured in this example to assign a low score to the familiarity factor used to generate the vulnerability score. Finally, if the user device 102 is connected to a low-speed and/or otherwise limited-connectivity connection such as a direct-to-cell satellite network connection provided by the direct-to-cell satellite network 110, the server computer 116 can be configured to determine that seeking help and/or communicating with others may be slow and/or difficult, and may therefore assign a low value to the connectivity factor. In weighing these factors, the server computer 116 can determine a vulnerability score (which can depend greatly in some cases upon weighting as mentioned herein). In this example, the vulnerability score may be indicated as indicating a high vulnerability. It should be understood that this example embodiment is illustrative, and therefore should not be construed as being limiting in any way.

In various embodiments of the concepts and technologies disclosed herein, the location factor can be based on data stored by the server computer 116. In other embodiments, the location factor may be determined by the server computer 116 based on information obtained from other devices or entities. For example, the server computer 116 can be configured to obtain geographic-specific data (“geodata”) 126 such as demographic information, crime reports, first responder response time data, population density information, and the like. In various embodiments, the geodata 126 can be provided to the server computer 116 by one or more geodata databases 128 or the like, which can host and/or serve the geodata 126 on request, automatically, and/or at other times. It also can be appreciated that the server computer 116 can be configured to obtain location-specific geodata 126 from the geodata database 128 upon identifying a geographic location (e.g., from the device data 118) in various embodiments. It should be understood that this example embodiment is illustrative, and therefore should not be construed as being limiting in any way.

In some other embodiments, other factors may be considered by the server computer 116 when generating the vulnerability score. For example, the device data 118 can include, in the other data, identifications of one or more other users or devices (e.g., other devices 130) in an immediate proximity of the user device 102. A determination as to if any other devices 130 are in an immediate proximity of the user device 102, and if so how many such other devices 130 are present, can affect the vulnerability score, for example based on an assumption that other people in proximity to the user device 102 would assist a user of the user device 102 in an emergency situation. Thus, the vulnerability score can be calculated in some embodiments based on a fourth factor that reflects presence (or lack thereof) of one or more other devices 130. It should be understood that this example embodiment is illustrative, and therefore should not be construed as being limiting in any way.

In some other embodiments, a fifth factor based on biometric data associated with the user device 102 may be included in the calculation of the vulnerability score. In particular, the device data 118 can include biometric data that can define physical conditions of a user of the user device 102 such as, for example, a pulse rate, a blood pressure, or the like. If the user is determined, based on the biometric data, to be calm or excited, this can be determined by the server computer 116 to affect the vulnerability score. In particular, the server computer 116 may be configured to assume more vulnerability for the user if the user is excited and less vulnerability for the user if the user is calm. It should be understood that this example embodiment is illustrative, and therefore should not be construed as being limiting in any way.

It should be understood that the above factor-based calculation of a vulnerability score using observable and historical conditions is only one example embodiment of the concepts and technologies disclosed herein. Other contemplated embodiments for calculating the vulnerability score include a rule-based calculation of the vulnerability score using observable, historical, and/or non-observable conditions. Some factors or rules can be subjective (e.g., familiarity, or the like) and some may be objective (e.g., a crime rate, a signal strength, or the like). In some embodiments, the coverage management service 114 can include a process or module for calculating the vulnerability score, or can invoke a remote process or module for calculating the vulnerability score based on historical and/or present conditions and/or factors.

In some example embodiments, the coverage management service 114 can invoke, call, and/or include a machine learning module or process. The machine learning can create one or more models for vulnerability based on artificial intelligence and/or other machine learning technologies that can build models for vulnerability based on the coverage maps, crime statistics, historical data (e.g., familiarity as observed and/or calculated for various users), emergency services response times, and the like. As such, it can be appreciated that the vulnerability score illustrated and described herein can be calculated based on rules-based approaches, factor-based approaches, and/or modeled using artificial intelligence and/or other machine learning processes including, but not limited to, generative artificial intelligence, neural networks, and the like. Because other technologies are possible and are contemplated, it should be understood that these example embodiments are illustrative, and therefore should not be construed as being limiting in any way.

Based on the determined vulnerability, the server computer 116 can be configured to take various actions. In some embodiments, the server computer 116 can be configured to make the record (and/or data thereof such as the vulnerability score and current location of the user device 102) available to one or more third party devices 132 such as, for example, first responder computer systems (e.g., centralized computer systems, distributed vehicle computer systems, or the like), services, applications, or the like. In some embodiments, the third party device 132 may be granted direct access to the data store 124 and/or user database 122, while in some other embodiments the server computer 116 may be configured to send an alert 134 to the third party device 132 to inform the third party device 132 about the vulnerability score, current geographic location, and/or other information associated with the user device 102. It should be understood that this example embodiment is illustrative, and therefore should not be construed as being limiting in any way.

In some embodiments, the server computer 116 can be configured to send alerts 134 to other devices such as, for example, the user device 102 and the contact device 120. Although not visible in FIG. 1, it should be understood that the alerts 134 can also be sent by the server computer 116 to the other device 130. The alerts 134 can indicate, to recipients, a vulnerability score for the user device 102, a current geographic location of the user device 102, and the like. In some embodiments, the devices that receive the alert 134 can present a user interface (e.g., for a user or other entity) that reflects the vulnerability and/or location of the user device 102. It should be understood that this example embodiment is illustrative, and therefore should not be construed as being limiting in any way.

The server computer 116 also can be configured, in some embodiments, to determine that traffic associated with the user device 102 should be prioritized based on the vulnerability score associated with the user device 102. For example, if the server computer 116 determines that the user device 102 is located in what the server computer 116 defines (e.g., based on vulnerability score limits, thresholds, or the like) as a high vulnerability of a defined level, the server computer 116 can determine that traffic associated with the user device 102 should be prioritized (e.g., to increase a speed with which help requests such as 911 calls are completed). The server computer 116 can be configured to generate a prioritization command (“command”) 136 and provide the command 136 to the direct-to-cell satellite network 110. The direct-to-cell satellite network 110 can be configured to prioritize traffic associated with the user device 102 based on receiving the command 136 in various embodiments. As such, embodiments of the concepts and technologies disclosed herein can provide alerting and prioritization relating to the user device 102 based on calculated vulnerability scores. It should be understood that this example embodiment is illustrative, and therefore should not be construed as being limiting in any way.

In practice, a user device 102 can be configured to execute a coverage management application 108 that can monitor geographic location of the user device 102, biometric readings at biometric sensors of (or in communication with) the user device 102, historical usage information associated with the user device 102 (e.g., locations at which the user device 102 has been located, activity of the user device 102 at various locations, combinations thereof, or the like), and other information. The user device 102 can be configured to detect when a change in a network connection occurs at the user device 102 such as, for example, the user device 102 connects to a direct-to-cell satellite network connection provided by a direct-to-cell satellite network 110 with no backup connection available. In response to detecting such a change in the network connection, the user device 102 can be configured to create device data 118 that can include identity data that identifies the user device 102 and/or a user thereof, connection data that identifies a current network connection of the user device 102, contact data that identifies new or updated contacts designated for the user device 102, biometric data that includes biometric sensor readings for a user associated with the user device 102, historical usage data that defines historical usage information for the user device 102, and/or other data such as indications of whether any other devices 130 are located in proximity to the user device 102 (and if so how many), preferences, settings, or the like. The user device 102 can also update a user interface based on detecting the change in the network connection at the user device 102. The user device 102 can send the device data 118 to a coverage management service 114 hosted and/or executed by the server computer 116. It should be understood that this example embodiment is illustrative, and therefore should not be construed as being limiting in any way.

The server computer 116 can analyze the device data 118 and create and/or update a record in a user database 122 that is maintained for the user device 102. The server computer 116 can update the record, for example, to indicate the current network connection for the user device 102 and a current vulnerability score for the user device 102. The vulnerability score can reflect a degree of vulnerability for the user device 102 based on the device data 118 and therefore can be based, in some embodiments, on location, familiarity of the user of the user device 102 with the location, how many other devices 130 are in proximity to the user device 102, geodata 126 that defines crime statistics and/or demographics for the location, combinations thereof, or the like. The server computer 116 can determine if the vulnerability score indicates a high vulnerability of the user device 102 and, if so, can generate alerts 134 and/or commands 136. It should be understood that this example embodiment is illustrative, and therefore should not be construed as being limiting in any way.

The server computer 116 can generate alerts 134 for the user device 102, the contact device 120, and/or the third party device 132. The alerts 134 can indicate the high vulnerability condition at the user device 102 and can include, in some embodiments, an indication of a current geographic location of the user device 102, options or instructions for reducing the vulnerability of the user device 102, and/or other information. The recipients of the alerts 134 can be configured to present and/or update user interfaces based on the alerts 134, in various embodiments. The recipients of the alerts 134 can also be configured to take various actions on the alerts 134, if desired, such as taking actions to reduce vulnerability of the user device 102 (e.g., by the user device 102), contacting authorities to obtain assistance for the user device 102 (e.g., by the contact device 120), assisting the user device 102 (e.g., by the third party associated with the third party device 132), and the like. Actions taken by the user device 102 can include navigating to a geographic location at which the connectivity is not as limited as the current network connection provided by the direct-to-cell satellite network 110, navigating to a location at which the familiarity of the user of the user device 102 is higher than at the current location, navigating to a location at which emergency services respond quicker than at a current location, navigating to a location at which more other device 130 are located, combinations thereof, or the like. It should be understood that this example embodiment is illustrative, and therefore should not be construed as being limiting in any way.

The server computer 116 also can generate the commands 136, which can include instructions for prioritizing communications associated with the user device 102. The server computer 116 can send the commands 136 to the direct-to-cell satellite network 110 and/or a device thereof. The direct-to-cell network 110 can be configured to prioritize communications of the user device 102 on the direct-to-cell network 110 in response to the command 136, thereby reducing vulnerability of the user device 102. It should be understood that this example embodiment is illustrative, and therefore should not be construed as being limiting in any way.

FIG. 1 illustrates one user device 102, one network 104, one direct-to-cell satellite network 110 having one satellite, one wireless network 112, one server computer 116, one contact device 120, one data store 124, one geodata database 128, one other device 130, and one third party device 132. It should be understood, however, that various implementations of the operating environment 100 can include one or more than one user device 102; one or more than one network 104; one or more than one direct-to-cell satellite network 110 (one or more of which may have one or more than one satellite); one or more than one wireless network 112; one or more than one server computer 116; zero, one, or more than one contact device 120; zero, one, or more than one data store 124; zero, one, or more than one geodata database 128; zero, one, or more than one other device 130; and/or zero, one, or more than one third party device 132. As such, the illustrated embodiment should be understood as being illustrative, and should not be construed as being limiting in any way.

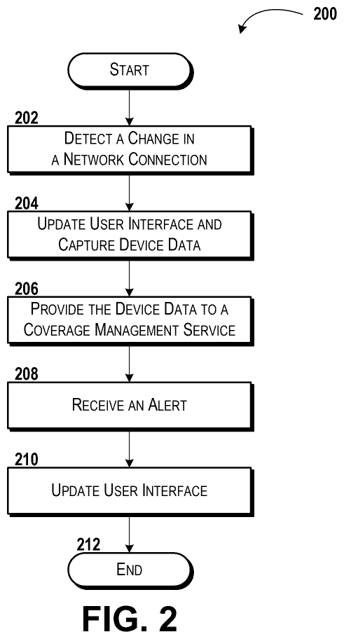

Turning now to FIG. 2, aspects of a method 200 for obtaining and presenting a vulnerability score during direct-to-cell satellite coverage will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the user device 102 and/or the server computer 116 to perform one or more operations and/or causing the processor to direct other components of the computing system or device to perform one or more of the operations.

For purposes of illustrating and describing the concepts of the present disclosure, the method 200 is described herein as being performed by the user device 102 via execution of one or more software modules such as, for example, the coverage management application 108. It should be understood that additional and/or alternative devices and/or network nodes can provide the functionality described herein via execution of one or more modules, applications, and/or other software including, but not limited to, the coverage management application 108. Thus, the illustrated embodiments are illustrative, and should not be viewed as being limiting in any way.

The method 200 begins at operation 202. At operation 202, the user device 102 can detect a change in a network connection of the user device 102. In operation 202, for example, the user device 102 can detect that the user device 102 has connected to a network connection other than a previous network connection, has connected to a network connection in addition to a previous network connection to which the user device 102 was connected, disconnected from one or more network connections to which the user device 102 was connected, or the like. In some embodiments, operation 202 can include the user device 102 connecting to a network connection associated with a direct-to-cell satellite network 110 as a primary network connection, as a backup network connection, or the like; the user device 102 connecting to a network connection associated with the wireless network 112 as a primary network connection, backup network connection, or the like; the user device 102 disconnecting from one or more network connections; combinations thereof; or the like.

Thus, operation 202 can include the user device 102 detecting any sort of connection to, or disconnection from, a network connection. In various embodiments, the network connection change detected in operation 202 can correspond to the user device 102 connecting to a network connection that can have limited connectivity such as a connection with the direct-to-cell satellite network 110. As used herein, “limited connectivity” can be used to describe a network connection that can be, for example, limited in terms of latency (e.g., have a high latency or lag such as a latency over one hundred milliseconds, two hundred milliseconds, five hundred milliseconds, one second, or the like) and/or bandwidth (e.g., having a bandwidth limited to less than one megabit per second, less than five hundred kilobits per second, less than one hundred kilobits per second, or the like), and the like, which may frequently be the case for direct-to-cell satellite network connections.

It can be appreciated that limits on bandwidth and/or latency (e.g., limits as to what is defined in embodiments of the concepts and technologies disclosed herein as “high latency” and/or “low bandwidth” for purposes of defining a connection as “limited”) can be defined by settings, configurations, user preferences, and the like. In any event, operation 202 can also include the user device 102 determining that a limited-connectivity connection is a primary connection and that this connection exists for the user device 102 with or without any backup network connection that has improved performance relative to the network connection with the direct-to-cell satellite network 110, for example, a cellular connection, a WiFi connection, or the like. It should be understood that this example embodiment is illustrative, and therefore should not be construed as being limiting in any way. As used in the claims, the phrase “limited-connectivity” can refer to a network connection to which the user device 102 is connected, where the network connection has a high latency or lag and/or low bandwidth, and where the user device 102 does not have a backup network connection available.

From operation 202, the method 200 can proceed to operation 204. At operation 204, the user device 102 can update a user interface and capture (and/or create) the device data 118. In particular, operation 204 can correspond to the user device 102 updating a user interface at the user device 102 (e.g., to show the new or changed network connection(s) detected in operation 202) and capturing the components of the device data 118 illustrated and described herein including, but not limited to, identity data that can identify the user device 102 and/or a user thereof, connection data that can identify the current network connection(s) and/or status thereof for the user device 102, contact data for contacts defined for the user device 102 (if any and/or if any have changed), biometric data that can include biometric sensors captured via the biometric sensors, historical usage data defining past location and activity history for the user device 102, and/or other data (e.g., identifying one or more other devices 130 in proximity to the user device 102) that can be included in the device data 118 as illustrated and described herein. Thus, operation 204 can include the user device 102 generating the device data 118 illustrated and described herein (e.g., due to the detected change in the network connection). It should be understood that this example embodiment is illustrative, and therefore should not be construed as being limiting in any way.

From operation 204, the method 200 can proceed to operation 206. At operation 206, the user device 102 can provide the device data 118 that was captured and/or created in operation 204 to the coverage management service 114 (and/or to the server computer 116 that hosts and/or executes the coverage management service 114). In various embodiments of the concepts and technologies disclosed herein, operation 206 can correspond to the user device 102 transmitting the device data 118 to the server computer 116, publishing the device data 118, releasing the device data 118, injecting the device data 118 into a data stream, combinations thereof, or the like. Because the user device 102 can provide and/or make available the device data 118 to the coverage management service 114 in additional and/or alternative manners, it should be understood that this example embodiment is illustrative, and therefore should not be construed as being limiting in any way.

From operation 206, the method 200 can proceed to operation 208. At operation 208, the user device 102 can receive an alert 134. The alert 134 received in operation 208 can correspond to the server computer 116 generating and sending an alert 134 that indicates that the user device 102 has a high vulnerability score at a current time, a determination that can be made by the server computer 116 as illustrated and described herein. It should be understood that this example embodiment is illustrative, and therefore should not be construed as being limiting in any way.

From operation 208, the method 200 can proceed to operation 210. At operation 210, the user device 102 can update a user interface at the user device 102. The user device 102 can update a user interface to indicate, for example to a user of the user device 102, that the user device 102 currently has a vulnerability score that indicates a high vulnerability. In some embodiments, the alert 134 can include instructions or suggestions for the user device 102 to improve its vulnerability score such as, for example, instructions to move to a location at which the connectivity of the user device 102 will be improved (e.g., where a network connection other than or in addition to the direct-to-cell satellite network connection is available), to move to a location with which the user is familiar, to move to a location where help is more readily available, combinations thereof, or the like. Because additional and/or alternative actions can be performed to improve the vulnerability score, it should be understood that these example embodiments are illustrative, and therefore should not be construed as being limiting in any way.

From operation 210, the method 200 can proceed to operation 212. The method 200 can end at operation 212.

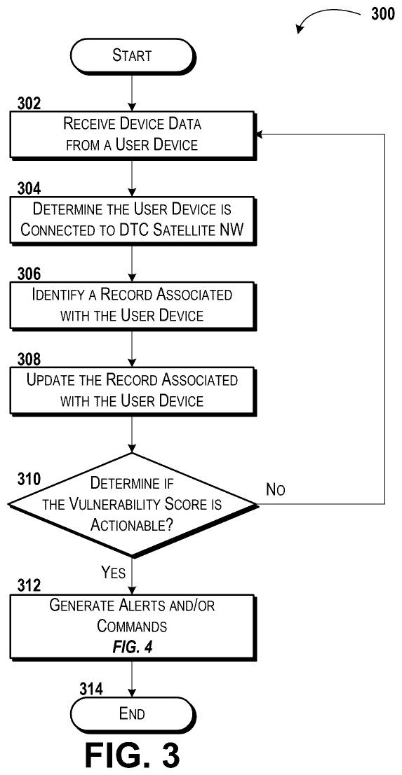

Turning now to FIG. 3, aspects of a method 300 for computing and using a vulnerability score during direct-to-cell satellite coverage will be described in detail, according to an illustrative embodiment. For purposes of illustrating and describing the concepts of the present disclosure, the method 300 is described herein as being performed by the server computer 116 via execution of one or more software modules such as, for example, the coverage management service 114. It should be understood that additional and/or alternative devices and/or network nodes can provide the functionality described herein via execution of one or more modules, applications, and/or other software including, but not limited to, the coverage management service 114. Thus, the illustrated embodiments are illustrative, and should not be viewed as being limiting in any way.

The method 300 begins at operation 302. At operation 302, the server computer 116 can receive device data 118 from a user device 102. According to various embodiments of the concepts and technologies disclosed herein, the user device 102 can be configured to send the device data 118 to the server computer 116 when a network connection change is detected at the user device 102, at regular and/or irregular time intervals, on request from the server computer 116 and/or other devices or entities, when the user device 102 detects certain network connection changes (e.g., connection to or disconnection from the direct-to-cell satellite network 110, when no backup connection exists, when bandwidth and/or latency drops below a defined threshold, combinations thereof, or the like), when conditions at the user device 102 change (e.g., the presence or lack of presence of other devices 130 in proximity to the user device 102, or the like), when biometric measurements and/or overall conditions (e.g., calmness, anxiety, or the like) change, combinations thereof, or the like.

In some embodiments, the user device 102 can be configured to create and send the device data 118 to the server computer 116 under limited circumstances. In particular, the user device 102 can be configured, in some embodiments, to send the device data 118 to the server computer 116 only when the user device 102 detects the establishment of a connection with a direct-to-cell satellite network 110 with limited or no backup network connection, and/or when the user device 102 detects that a new network connection has been established as a primary or backup network after previously being connected only to a direct-to-cell satellite network 110 with limited or no backup network connection. Because the device data 118 can be provided to the server computer 116 in additional and/or alternative circumstances, it should be understood that these example embodiments are illustrative, and therefore should not be construed as being limiting in any way.

From operation 302, the method 300 can proceed to operation 304. At operation 304, the server computer 116 can determine that the user device 102 is connected to a direct-to-cell satellite network 110 (and/or a network connection thereto). In particular, the server computer 116 can determine, in operation 304 a network status of the user device 102 and detect that a network connection of the user device 102 corresponds to a connection to a satellite associated with a direct-to-cell satellite network 110. In operation 304, for example, the server computer 116 can analyze the device data 118 to determine what network connections exist for the user device 102 at a current time, and as explained herein the device data 118 can indicate a current network connection of the user device 102. Thus, based on analysis of the device data 118, the server computer 116 can determine the current network connection of the user device 102. In some contemplated example embodiments of the concepts and technologies disclosed herein, for example, the server computer 116 may determine in operation 304 that the user device 102 is currently connected to a direct-to-cell satellite network 110 with no backup network connection or a direct-to-cell satellite network 110 with a limited backup connection. In either event, the server computer 116 may determine that the user device 102 currently has a network connection with limited connectivity. It should be understood that this example embodiment is illustrative, and therefore should not be construed as being limiting in any way.

From operation 304, the method 300 can proceed to operation 306. At operation 306, the server computer 116 can identify a record associated with the user device 102. In some embodiments, the server computer 116 can identify the record for the user device 102 based on identity information that can be included in the record and identify data included in the device data 118, for example. Because the record associated with the user device 102 can be identified in additional and/or alternative manners, it should be understood that this example embodiment is illustrative, and therefore should not be construed as being limiting in any way. It should be understood that this example embodiment is illustrative, and therefore should not be construed as being limiting in any way.

From operation 306, the method 300 can proceed to operation 308. At operation 308, the server computer 116 can update the record associated with the user device 102. Operation 308 can include at least the server computer 116 calculating a current vulnerability score for the user device 102 and updating the vulnerability score of the record associated with the user device 102. As explained herein, the server computer 116 can be configured to calculate the vulnerability score based on various factors, which can include in some embodiments one or more of a) a current network connection for the user device 102 and capabilities of the current network connection, b) a current geographic location of the user device 102 and geodata 126 associated with the geographic location such as first responder response times, crime statistics, and the like, c) familiarity of the user of the user device 102 at the current geographic location of the user device 102, d) a number of other devices 130 in proximity to the user device 102, e) biometric conditions of the user of the user device 102 (e.g., whether the user is calm, anxious, or the like), f) other considerations, combinations thereof, or the like. Thus, the server computer 116 can be configured to extract the data used for the factors of the vulnerability score in operation 308, to calculate the vulnerability score, and update the vulnerability score reflected by the record associated with the user device 102. It should be understood that this example embodiment is illustrative, and therefore should not be construed as being limiting in any way.

From operation 308, the method 300 can proceed to operation 310. At operation 310, the server computer 116 can determine if the vulnerability score included in the record associated with the user device 102 (as updated in operation 308) is actionable (or that the vulnerability score is acceptable or unacceptable). Operation 310 can include the server computer 116 determining if the vulnerability score calculated in operation 308 meets some limit, threshold, or the like. For example, the server computer 116 can determine that the vulnerability score is actionable if the server computer 116 determines that the vulnerability score exceeds a defined vulnerability score threshold, falls under a defined vulnerability score threshold, exceeds or fails to meet a defined vulnerability score limit, or the like. In various embodiments, operation 310 can correspond to the server computer 116 determining that a current vulnerability score associated with the user device 102 indicates a high vulnerability for the user device 102 (e.g., a score of high on a three-score scale including low, medium and high; a score of high on a five-score scale including low, medium-low, medium, medium-high, and high; a score in excess of ninety or ninety-five on a scale of one to one hundred; or the like). Because other scales are possible and are contemplated, it should be understood that the server computer 116 can determine that the user device 102 is experiencing high vulnerability in a variety of manners and it should be understood that these example embodiments are illustrative, and therefore should not be construed as being limiting in any way.

If the server computer 116 determines, in operation 310, that a vulnerability score associated with the user device 102 is not actionable (or determines that the vulnerability score is acceptable), the method 300 can return to operation 302 (and another iteration of the device data 118 can be obtained by the server computer 116 at some time). Thus, it can be appreciated that operations 302-310 can be iterated until the server computer 116 determines, in any iteration of operation 310, that the vulnerability score (e.g., as updated in a current iteration of operation 308) is actionable. If the server computer 116 determines, in any iteration of operation 310, that the vulnerability score associated with the user device 102 is actionable (or unacceptable), the method 300 can proceed to operation 312.

At operation 312, the user device 102 can generate alerts 134 and/or commands 136. In various embodiments of the concepts and technologies disclosed herein, the alerts 134 can include an indication that the user device 102 currently has a vulnerability score that indicates high vulnerability. The alerts 134 also can include, in some embodiments, an indication of a current location of the user device 102. The alerts 134 also can include, in some embodiments, instructions for the user device 102 to move to a location at which the vulnerability score will improve (e.g., the vulnerability of the user device 102 will be decreased) such as instructions to navigate to a location at which high-speed and/or low-latency network connections are available (e.g., in the wireless network coverage area CA_{w}, for example), instructions to navigate to a location at which emergency services respond faster than at the current location of the user device 102, combinations thereof, or the like. In operation 312, the server computer 116 can generate the alerts 134 and send the alerts 134 to one or more recipients such as, for example, the user device 102, the contact device 120, the other device 130, the third party device 132, combinations thereof, or the like. It should be understood that this example embodiment is illustrative, and therefore should not be construed as being limiting in any way.

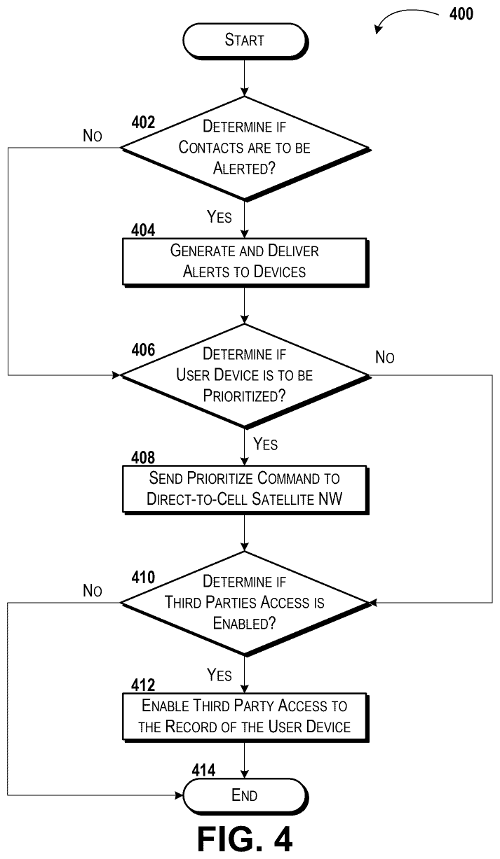

Operation 312 can also include the server computer 116 determining that traffic associated with the user device 102 should be prioritized by the direct-to-cell satellite network 110. Thus, the server computer 116 can be configured to generate a command 136 that orders the direct-to-cell satellite network 110 (or a component thereof) to prioritize traffic associated with the user device 102. It should be understood that this example embodiment is illustrative, and therefore should not be construed as being limiting in any way. Some additional details of generating and delivering alerts 134 and/or commands 136 will be illustrated and described in more detail hereinbelow with reference to FIG. 4. It should be understood that these example embodiments are illustrative, and therefore should not be construed as being limiting in any way.

From operation 312, the method 300 can proceed to operation 314. The method 300 can end at operation 314.

Turning now to FIG. 4, aspects of a method 400 for generating alerts and commands based on vulnerability scores during direct-to-cell satellite coverage will be described in detail, according to an illustrative embodiment. For purposes of illustrating and describing the concepts of the present disclosure, the method 400 is described herein as being performed by the server computer 116 via execution of one or more software modules such as, for example, the coverage management service 114. It should be understood that additional and/or alternative devices and/or network nodes can provide the functionality described herein via execution of one or more modules, applications, and/or other software including, but not limited to, the coverage management service 114. Thus, the illustrated embodiments are illustrative, and should not be viewed as being limiting in any way.

The method 400 begins at operation 402. At operation 402, the server computer 116 can determine if one or more contacts (associated with the user device 102) are to be alerted regarding the vulnerability of the user device 102. In operation 402, the server computer 116 can analyze the record associated with the user device 102 to determine if any contacts have been defined for the user device 102, if any of those contacts have been designated as recipients of vulnerability information (e.g., vulnerability scores associated with the user device 102, current location information for the user device 102, and/or the like), and what preferences have been defined for such alerting such as, for example, under what conditions alerts 134 should be delivered, and the like. The server computer 116 can also determine, in operation 402, if any third party devices 132 are to be alerted and/or if the user device 102 is to be alerted. It should be understood that this example embodiment is illustrative, and therefore should not be construed as being limiting in any way.

If the server computer 116 determines, in operation 402, that one or more contacts associated with the user device 102 are to be alerted, the method 400 can proceed to operation 404. At operation 404, the server computer 116 can generate and deliver one or more alerts 134 to one or more devices. In operation 404, the server computer 116 can identify one or more recipients for the alerts 134 including, but not limited to, the user device 102, the contact devices 120, the third party devices 132, and the like. The server computer 116 also can determine, in operation 404, what information is to be included in the alerts 134 for each recipient.

In particular, in operation 404, the server computer 116 can determine, for alerts 134 being delivered to the user device 102, if options exist and/or are requested to be provided to the user device 102 (either by preferences or based on queries of the user device 102 and/or a user thereof) to improve a vulnerability score. If the server computer 116 determines that options to reduce vulnerability are to be provided to the user device 102, the server computer 116 can identify such options and include the options in the alerts 134 delivered to the user device 102. It should be understood that this example embodiment is illustrative, and therefore should not be construed as being limiting in any way.

In some embodiments, the server computer 116 can identify an option to reduce vulnerability of the user device 102 by identifying a closest network connection that is not limited (e.g., a closest geographic location at which the user device 102 can access a network connection other than and/or in addition to the direct-to-cell connection) and create instructions for the user device 102 to move to that location (e.g., navigation instructions, or the like). In some other embodiments, the server computer 116 can identify an option to reduce vulnerability of the user device 102 by identifying a closest geographic location at which emergency service response time meets a defined threshold that would improve the vulnerability score (e.g., a closest geographic location at which the user device 102 can obtain help within a defined response time such as five minutes, three minutes, one minute, or the like) and create instructions for the user device 102 to move to that location (e.g., navigation instructions, or the like). Because other options are possible and are contemplated, it should be understood that these example embodiments are illustrative, and therefore should not be construed as being limiting in any way.

In operation 404 the server computer 116 can also determine what information is to be provided to the contact devices 120 such as, for example, an indication as to the vulnerability score, an indication as to the current location of the user device 102, and the like. If the server computer 116 determines that the vulnerability score and/or current location of the user device 102 are to be provided to the contact devices 120, the server computer 116 can identify the vulnerability score and the current location and include that information in the alerts 134 that are being provided to the contact devices 120. It should be understood that this example embodiment is illustrative, and therefore should not be construed as being limiting in any way.

In operation 404 the server computer 116 can also determine what information is to be provided to the third party devices 132 such as, for example, an indication as to the vulnerability score, an identity of the user associated with the user device 102, an indication as to the current location of the user device 102, and the like. If the server computer 116 determines that these and/or other information is to be provided to the third party devices 132 as part of an alert 134, the server computer 116 can identify the pertinent information and include that information in the alerts 134 that are being provided to the third party devices 132. It should be understood that this example embodiment is illustrative, and therefore should not be construed as being limiting in any way. In operation 404, the server computer 116 can send the alerts 134 to the identified recipients and/or trigger delivery of the alerts 134 to the recipients by other devices or entities. It should be understood that this example embodiment is illustrative, and therefore should not be construed as being limiting in any way.

From operation 404, the method 400 can proceed to operation 406. The method 400 also can proceed to operation 406 if the server computer 116 determines, in operation 402, that there are no contacts associated with the user device 102 and/or that no contacts associated with the user device 102 are to be alerted. At operation 406, the server computer 116 can determine if the user device 102 is to be prioritized due to the vulnerability score computed for the user device 102 (e.g., in operation 308 of the method 300 illustrated and described with reference to FIG. 3). In some embodiments, configurations and/or settings defined for the coverage management service 114 can indicate that traffic associated with the user device 102 is to be prioritized by the direct-to-cell satellite network 110 if the user device 102 does not have any defined contacts or other recipients of alerts 134 (e.g., the third party device 132) other than the user device 102 itself. In some other embodiments, the server computer 116 can be configured to prioritize communications of the user device 102 even if there are defined contacts and/or other recipients of the alerts 134. Thus, in operation 406, the server computer 116 can determine that communications of the user device 102 are to be prioritized. It should be understood that this example embodiment is illustrative, and therefore should not be construed as being limiting in any way.

If the server computer 116 determines, in operation 406, that the user device 102 is to be prioritized due the vulnerability score computed for the user device 102, the method 400 can proceed to operation 408. At operation 408, the server computer 116 can generate a command 136. The command 136 can indicate that communications associated with the user device 102 are to be prioritized by the direct-to-cell satellite network 110. Thus, while the direct-to-cell satellite network connection provided by the direct-to-cell satellite network 110 may be defined herein as a “limited-connectivity” connection (e.g., have a high latency or lag and/or a low bandwidth), prioritization of traffic associated with the user device 102 can result in improved performance by the direct-to-cell satellite network connection for traffic associated with the user device 102 (relative to unprioritized traffic). Thus, the direct-to-cell satellite network 110 may respond to any request associated with a prioritized device before any other pending requests (thereby taking the requests out of order, or the like; reduce latency; and/or otherwise prioritize communications associated with the user device 102). It should be understood that this example embodiment is illustrative, and therefore should not be construed as being limiting in any way.

From operation 408, the method 400 can proceed to operation 410. The method 400 also can proceed to operation 410 if the server computer 116 determines, in operation 406, that the user device 102 is not to be prioritized due the vulnerability score computed for the user device 102. At operation 410, the server computer 116 can determine if third parties access (e.g., to the vulnerability score for the user device 102 and/or to other information from the record for the user device 102) is enabled. Operation 410 can include the server computer 116 accessing the settings and/or preferences defined for the user device 102 (e.g., in the record) and determining, based on an analysis of the settings and preferences, if third party access to the record associated with the user device 102 is enabled. If the server computer 116 determines, in operation 410, that third parties access (e.g., to the vulnerability score for the user device 102 and/or to other information from the record for the user device 102) is enabled, the method 400 can proceed to operation 412.

At operation 412, the server computer 116 can enable third party access to the record. Thus, in operation 412 the server computer 116 may make the record available to direct access to the data store 124, send the record to the third party device 132, combinations thereof, or the like. As such, the server computer 116 can make the record available for third party devices 132 in various manners. As such, it should be understood that this example embodiment is illustrative, and therefore should not be construed as being limiting in any way.

From operation 412, the method 400 can proceed to operation 414. The method 400 also can proceed to operation 412 if the server computer 116 determines, in operation 410, that third parties access (e.g., to the vulnerability score for the user device 102 and/or to other information from the record for the user device 102) is not enabled and/or is disabled. The method 400 can end at operation 414.

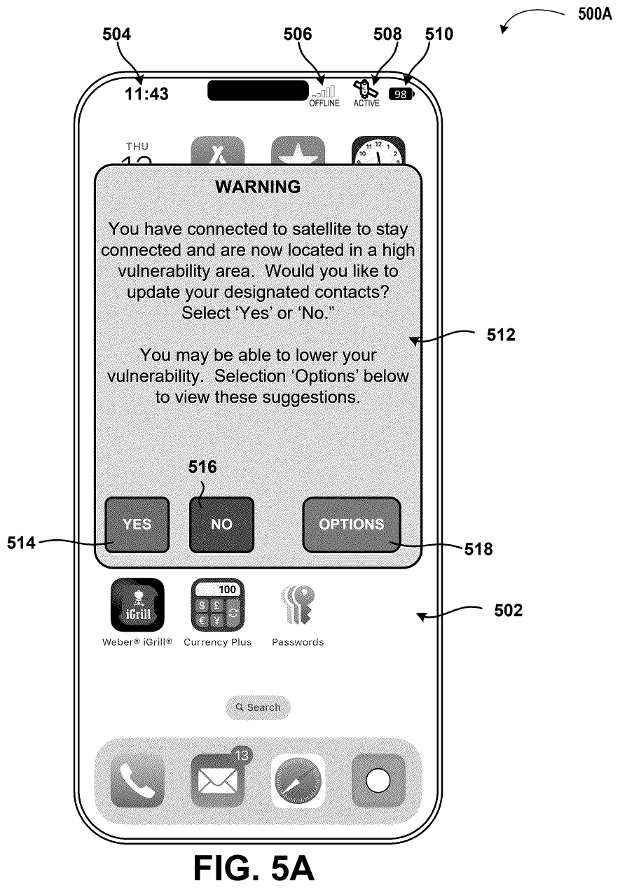

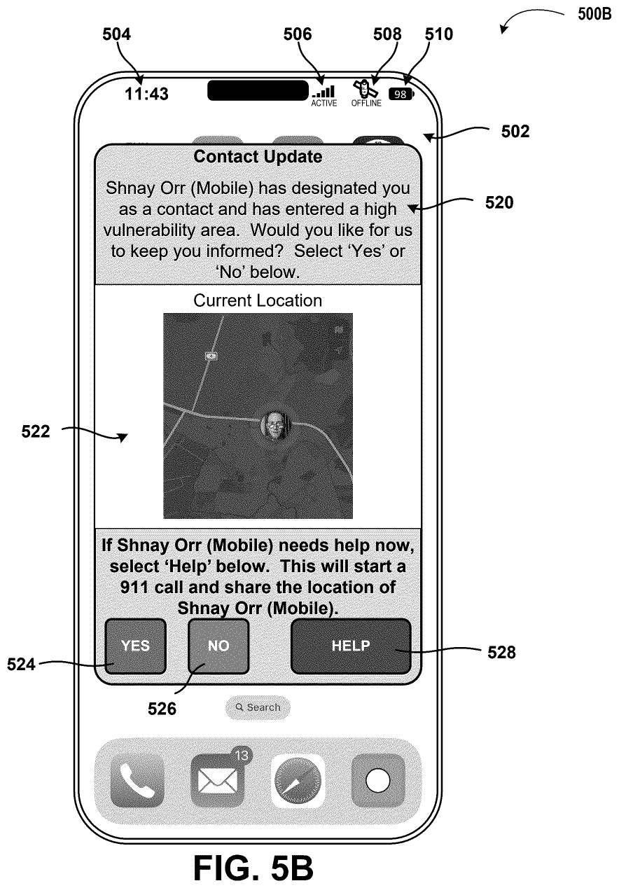

FIGS. 5A-5B are user interface (“UI”) diagrams showing aspects of UIs for using and/or interacting with the coverage management application 108 and/or the coverage management service 114, according to some illustrative embodiments. FIG. 5A shows an illustrative screen display 500A. According to some embodiments of the concepts and technologies described herein, the screen display 500A can be generated by a device such as the user device 102 via interactions with the coverage management application 108 and/or the coverage management service 114. It should be appreciated that the UI diagram illustrated in FIG. 5A is illustrative of one contemplated example of the UIs that can be generated and/or displayed in accordance with the concepts and technologies disclosed herein, and therefore should not be construed as being limiting in any way.

According to various embodiments, the screen display 500A can be presented, for example, when the user device 102 has connected to a limited-connectivity network connection associated with a direct-to-cell satellite network 110 and has been determined, by the server computer 116 updating the record associated with the user device 102, as having a high vulnerability score. It can be appreciated with reference to the embodiments of the concepts and technologies disclosed herein that the user device 102 may determine that the user device 102 has connected to the limited connectivity connection based on detecting the active network connections locally and/or based on other information obtained from other devices, entities, or resources. It should be understood that this example embodiment is illustrative, and therefore should not be construed as being limiting in any way.

In the example screen display 500A shown in FIG. 5A, the user device 102 is illustrated as displaying a home screen 502. It should be understood that this example embodiment is illustrative, and therefore should not be construed as being limiting in any way. Because one or more elements of the screen display 500A illustrated in FIG. 5A can be displayed at additional and/or alternative times (e.g., when the user device 102 is locked), and because one or more elements of the screen display 500A may or may not be included in all embodiments, it should be understood that the illustrated example embodiment is illustrative and therefore should not be construed as being limiting in any way.

As is generally understood and as is illustrated in FIG. 5A, the home screen 502 can include various types of data and/or information such as time and/or date information 504, which can display a current time and/or date; carrier information (not illustrated in FIG. 5A), which can be included to indicate a carrier associated with a primary network connection and/or network to which the user device 102 is connected at the time; signal strength information 506 for the primary network connection, which can indicate a strength of a signal associated with the primary network to which the user device 102 is connected (or not connected) at the time; a WiFi signal indicator (not shown), which can indicate in some instances that a WiFi connection is available, active, and optionally an associated signal strength of the WiFi signal; a direct-to-cell satellite network connection indicator 508, which optionally can include an associated signal strength indicator (not shown); battery charge information 510; other information; combinations thereof; or the like.

As shown in FIG. 5A, a status of one or more networks can be displayed on the home screen 502 and/or elsewhere. In the illustrated embodiment, a status of “offline” is displayed under the signal strength information 506, thereby indicating that the primary network connection such as a cellular network connection to a terrestrial cellular network is not active at the current time; and a status of “active” is displayed under the direct-to-cell satellite network connection indicator 508, thereby indicating that a direct-to-cell satellite network connection is active and/or connected at the current time and is functioning as the only network connection for the user device 102. It should be understood that this example embodiment is illustrative, and therefore should not be construed as being limiting in any way.

According to various embodiments of the concepts and technologies disclosed herein, the screen display 500A also can include a vulnerability alert window 512. The vulnerability alert window 512 can be provided in various conditions illustrated and described herein to provide information about content, to obtain input from a user, to enable and/or disable options for obtaining content, combinations thereof, or the like. In the embodiment shown in FIG. 5A, the vulnerability alert window 512 is illustrated as indicating that the user device 102 has connected to a limited connectivity direct-to-cell satellite network connection, that the user device 102 is now located in a high vulnerability area (e.g., an area at which emergency services take more time to answer calls than a defined time limit, an area in which the user associated with the user device 102 is assumed to be unfamiliar, and the like as illustrated and described herein), and a query as to whether the user associated with the user device 102 wants to update contacts about the high vulnerability of the user device 102. The vulnerability alert window 512 also informs the user associated with the user device 102 that options for reducing vulnerability are available and providing a way to access those options. It should be understood that this example embodiment is illustrative, and therefore should not be construed as being limiting in any way.

The vulnerability alert window 512 can include a UI control 514 for selecting a “yes” option, a UI control 516 for selecting a “no” option, and a UI control 518 for selecting an “options” option. In the embodiment shown in FIG. 5A, selection of the UI control 514 can cause the user device 102 to inform a coverage management service 114 to deliver one or more alerts 134 to one or more contact devices 120 and/or third party devices 132 if such alerts 134 have not already been sent. Thus, it can be appreciated that selection of the UI control 514 can cause the user device 102 to confirm delivery of alerts 134 and/or to change preferences associated with the user device 102 (e.g., as part of the record in the user database 122) if such alerts 134 were not previously requested. Because additional and/or alternative actions can be taken in response to detecting selection of the UI control 514, it should be understood that this example embodiment is illustrative, and therefore should not be construed as being limiting in any way.

In the illustrated embodiment, selection of the UI control 516 can cause the user device 102 to indicate to the coverage management service 114 (or the server computer 116 that hosts and/or executes the coverage management service 114) that alerts 134 should not be sent. Thus, selection of the UI control 516 can cause the user device 102 to inform a coverage management service 114 to cancel delivery of one or more alerts 134 to one or more contact devices 120 if such alerts 134 have not already been sent, or to update preferences if such alerts 134 have been sent. Thus, it can be appreciated that selection of the UI control 516 can cause the user device 102 to cancel the attempted delivery of alerts 134 and/or to change preferences associated with the user device 102 (e.g., as part of the record in the user database 122). It should be understood that this example embodiment is illustrative, and therefore should not be construed as being limiting in any way.

The vulnerability alert window 512 can also include a UI control 518 for accessing one or more options to reduce vulnerability for the user device 102 as illustrated and described herein. As such, it can be appreciated that the user device 102 illustrated in FIG. 5A has already received an alert 134 indicating that the user device 102 is in a high vulnerability area, and the alert 134 provided to the user device 102 included data indicating one or more options for reducing vulnerability of the user device 102. As explained herein, the options to reduce vulnerability of the user device 102 can include, for example, navigating to an area at which emergency response times are shorter than at the current location of the user device 102; navigating to an area at which the user associated with the user device 102 has more familiarity with the area; navigating to an area at which the connectivity provided to the user device 102 by a network connection is not as limited in terms of performance (e.g., latency, lag, bandwidth, etc.) as the current network connection; navigating to an area at which additional other devices 130 are located; combinations thereof; or the like. Selection of the UI control 518 can cause the user device 102 to present the one or more options for the user to review. Because the illustrated embodiment of the screen display 500A is illustrative, and because the screen display 500A can include additional and/or alternative information, it should be understood that the embodiment of FIG. 5A is illustrative, and therefore should not be construed as being limiting in any way.

FIG. 5B shows an illustrative screen display 500B. According to some embodiments of the concepts and technologies described herein, the screen display 500B can be generated by a device such as the contact device 120 via interactions with the coverage management service 114 and/or an alert 134 received from the coverage management service 114. It should be appreciated that the UI diagram illustrated in FIG. 5B is illustrative of one contemplated example of the UIs that can be generated and/or displayed in accordance with the concepts and technologies disclosed herein, and therefore should not be construed as being limiting in any way.

According to various embodiments, the screen display 500B can be presented, for example, when the contact device 120 has received an alert 134 that indicates that the contact associated with the contact device 120 has been designated as a contact for the user device 102, that the user device 102 has connected to a limited-connectivity network connection associated with a direct-to-cell satellite network 110, and that the user device 102 has entered a high vulnerability area. Because the screen display 500B can be displayed at the contact device 120 and/or other devices at additional and/or alternative times, it should be understood that this example embodiment is illustrative, and therefore should not be construed as being limiting in any way.

In the example screen display 500B shown in FIG. 5B, the contact device 120 is illustrated as displaying a home screen 502. Because one or more elements of the screen display 500B illustrated in FIG. 5B can be displayed at additional and/or alternative times (e.g., when the contact device 120 is locked), and because one or more elements of the screen display 500B may or may not be included in all embodiments, it should be understood that the illustrated example embodiment is illustrative and therefore should not be construed as being limiting in any way.

As is illustrated in FIG. 5B, the home screen 502 can include time and/or date information 504; carrier information (not illustrated in FIG. 5B); signal strength information 506 for the primary network connection, which can indicate a strength of a signal associated with the primary network to which the contact device 120 is connected at the time; a WiFi signal indicator (not shown); the direct-to-cell satellite network connection indicator 508; battery charge information 510; one or more application icons (not numbered in FIG. 5B); other information, combinations thereof; or the like. As shown in FIG. 5B, a status of “active” is displayed under the signal strength information 506, thereby indicating that a primary network connection for the contact device 120, for example a cellular network connection to a terrestrial cellular network, is active at the current time. Also, a status of “offline” is displayed under the direct-to-cell satellite network connection indicator 508, thereby indicating that a direct-to-cell satellite network connection is inactive and/or unavailable for the contact device 120 at the current time. It should be understood that this example embodiment is illustrative, and therefore should not be construed as being limiting in any way.

According to various embodiments of the concepts and technologies disclosed herein, the screen display 500B includes a contact vulnerability alert window 520. In the embodiment shown in FIG. 5B, the contact vulnerability alert window 520 is illustrated as indicating that the user device 102 (who has designated a user associated with the contact device 120 as a contact) has connected to a limited connectivity direct-to-cell satellite network connection and is located in a high vulnerability area or situation. In this example embodiment, the contact device 120 has received an alert 134, and the alert 134 was sent with data indicating that the user device 102 has entered a high vulnerability area (or situation), that the contact device 120 has been designated as a contact in such situations, and a current geographic location of the user device 102. It should be understood that this example embodiment is illustrative, and therefore should not be construed as being limiting in any way.

As shown in FIG. 5B, the contact vulnerability alert window 520 includes a map display image 522, which can show the current location of the user device 102. In some embodiments, the map display image 522 can be a selectable UI control that, when selected at the contact device 120, causes the contact device 120 to present a navigable map display, obtain directions to the user device 102, combinations thereof, or the like. It should be understood that this example embodiment is illustrative, and therefore should not be construed as being limiting in any way.

As shown in FIG. 5B, the contact vulnerability alert window 520 can also include a prompt at the contact device 120 to make selections for being updated and/or obtaining help for the user device 102. In particular, the contact vulnerability alert window 520 can include a UI control 524 for entering a “yes” option, a UI control 526 for entering a “no” option, and a UI control 528 for entering a help option. In the embodiment shown in FIG. 5B, selection of the UI control 524 can cause the contact device 120 to indicate to the coverage management service 114 (hosted and/or executed by the server computer 116) that the contact device 120 wants to continue being updated regarding the vulnerability and/or location of the user device 102. It should be understood that this example embodiment is illustrative, and therefore should not be construed as being limiting in any way.

Similarly, selection of the UI control 526 can cause the contact device 120 to indicate to the coverage management service 114 (hosted and/or executed by the server computer 116) that the contact device 120 does not wish to be updated regarding vulnerability and/or location of the user device 102. It should be understood that this example embodiment is illustrative, and therefore should not be construed as being limiting in any way. The contact vulnerability alert window 520 also includes the UI control 528 for obtaining help for the user device 102. Thus, although not shown in the FIGURES, selection of the UI control 528 can cause the contact device 120 to send another form of alert to the third party device 132 and/or the server computer 116 for obtaining help for the user device 102. In some embodiments, selection of the UI control 528 can cause the contact device 120 to initiate an emergency call (e.g., a 911 call) and provide the location of the user device 102 (as obtained in the alert 134). It should be understood that this example embodiment is illustrative, and therefore should not be construed as being limiting in any way.

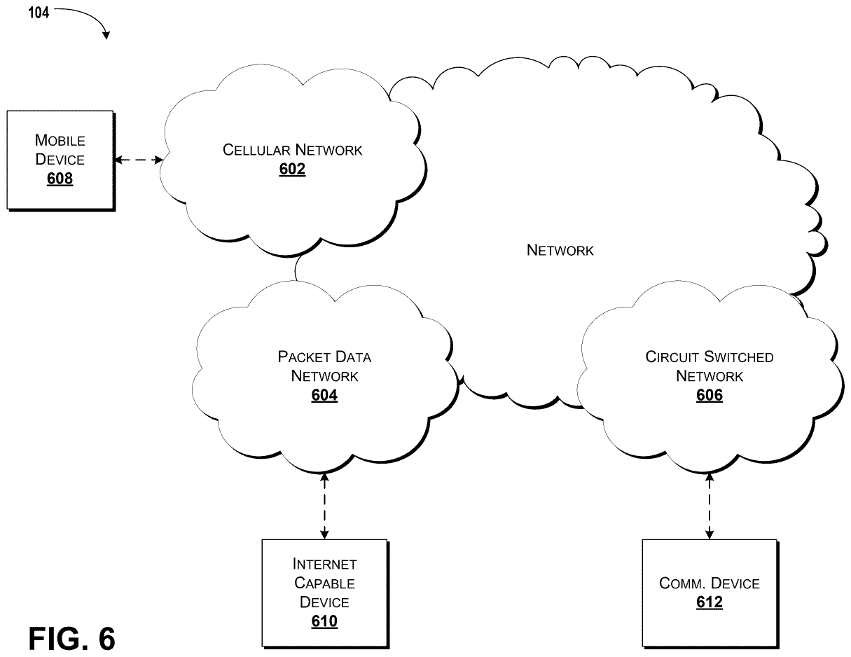

Turning now to FIG. 6, additional details of the network 104 are illustrated, according to an illustrative embodiment. The network 104 includes a cellular network 602, a packet data network 604, for example, the Internet, and a circuit switched network 606, for example, a publicly switched telephone network (“PSTN”). The cellular network 602 includes various components such as, but not limited to, base transceiver stations (“BTSs”), NodeB's or eNodeB's (“eNBs”), gNodeBs (“gNBs”), or the like; base station controllers (“BSCs”) radio network controllers (“RNCs”), or the like; an evolved packet core (“EPC”); mobile switching centers (“MSCs” or “MSSs”); session management functions (“SMFs); mobile management entities (“MMEs”); access and mobility management functions (“AMFs); authentication server functions (“AUSFs”), network slice selection functions (“NSSFs); network exposure functions (“NEFs”); policy control functions (“PCFs”); and various other functions in the user and control planes such as, for example, user plane functions (“UPFs), application functions (“AFs”), NF repository functions (“NRFs”), and the like; short message service centers (“SMSCs”); multimedia messaging service centers (“MMSCs”); home location registers (“HLRs”); home subscriber servers (“HSSs”); visitor location registers (“VLRs”); charging platforms; billing platforms; voicemail platforms; GPRS core network components; links to data networks (“DNs”) and/or other operator services, third party services, and/or the Internet; location service nodes, an IP Multimedia Subsystem (“IMS”); and the like. Of course, the cellular network 602 also can include various interfaces between various components, as is generally understood. The cellular network 602 also includes radios and nodes for receiving and transmitting voice, data, and combinations thereof to and from radio transceivers, networks, the packet data network 604, and the circuit switched network 606.

A mobile communications device 608, such as, for example, a cellular telephone, a user equipment, a mobile terminal, a PDA, a laptop computer, a handheld computer, and combinations thereof, can be operatively connected to the cellular network 602. The cellular network 602 can be configured as a 2G GSM network and can provide data communications via GPRS and/or EDGE. Additionally, or alternatively, the cellular network 602 can be configured as a 3G UMTS network and can provide data communications via the HSPA protocol family, for example, HSDPA, EUL (also referred to as HSUPA), and HSPA+. The cellular network 602 also is compatible with 4G mobile communications standards, 5G mobile communications standards, 6G mobile communication standards, other mobile communications standards, and evolved and future mobile communications standards. Moreover, the cellular network 602 may facilitate communications over various channel access methods (which may or may not be used by the aforementioned standards) including, but not limited to, TDMA, FDMA, W-CDMA, OFDM, SDMA, and the like. In addition, the cellular network 602 may facilitate data communications using GPRS, EDGE, the HSPA protocol family including HSDPA, EUL or otherwise termed HSUPA, HSPA+, and various other current and future wireless data access standards. Because additional and/or alternative mobile communications standards may be used in accordance with various embodiments of the concepts and technologies disclosed herein, it should be understood that these example embodiments are illustrative, and therefore should not be construed as being limiting in any way.

The packet data network 604 includes various devices, for example, servers, computers, databases, and other devices in communication with one another, as is generally known. The packet data network 604 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 604 includes or is in communication with the Internet. The circuit switched network 606 includes various hardware and software for providing circuit switched communications. The circuit switched network 606 may include, or may be, what is often referred to as a plain old telephone system (POTS). The functionality of a circuit switched network 606 or other circuit-switched network are generally known and will not be described herein in detail.

The illustrated cellular network 602 is shown in communication with the packet data network 604 and a circuit switched network 606, though it should be appreciated that this is not necessarily the case. One or more Internet-capable devices 610, for example, a PC, a laptop, a portable device, or another suitable device, can communicate with one or more cellular networks 602, and devices connected thereto, through the packet data network 604. It also should be appreciated that the Internet-capable device 610 can communicate with the packet data network 604 through the circuit switched network 606, the cellular network 602, and/or via other networks (not illustrated).

As illustrated, a communications device 612, for example, a telephone, facsimile machine, modem, computer, or the like, can be in communication with the circuit switched network 606, and therethrough to the packet data network 604 and/or the cellular network 602. It should be appreciated that the communications device 612 can be an Internet-capable device, and can be substantially similar to the Internet-capable device 610. In the specification, the network 104 is used to refer broadly to any combination of the networks 602, 604, 606. It should be appreciated that substantially all of the functionality described with reference to the network 104 can be performed by the cellular network 602, the packet data network 604, and/or the circuit switched network 606, alone or in combination with other networks, network elements, and the like.

As explained herein, the network 104 also can include and/or can access a direct-to-cell satellite network (not visible in FIG. 6). As is generally understood, a direct-to-cell satellite network can include one or more satellites (or constellations of satellites), which can be configured to communicate directly with a mobile device such as the user device 102 illustrated and described herein, which as explained herein can include and/or can be similar to the mobile communications device 608 shown in FIG. 6, a vehicle computing system (e.g., a communications device of a connected car system), and/or other devices that can use the direct-to-cell satellite network to bypass terrestrial wireless networks such as the cellular network 602 and/or some components thereof. The satellites of a direct-to-cell satellite network may be located in low earth orbit and therefore the coverage areas CAₛ of satellites of direct-to-cell satellite networks may move relative to the surface of the earth over time. Embodiments of the concepts and technologies disclosed herein can include connectivity to these and other networks as illustrated and described herein.

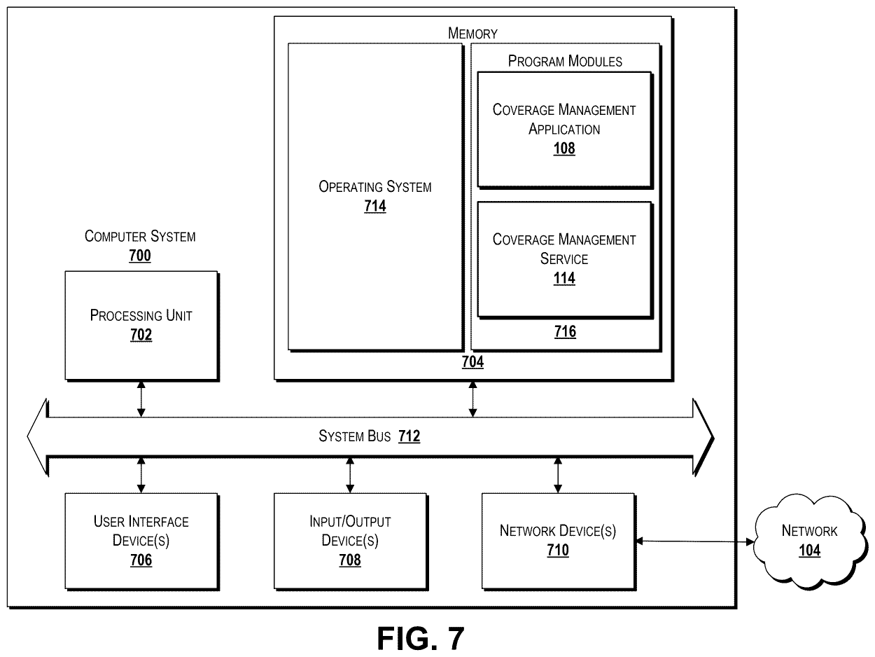

FIG. 7 is a block diagram illustrating a computer system 700 configured to provide the functionality described herein for providing determining and using vulnerability scores during direct-to-cell satellite coverage, in accordance with various embodiments of the concepts and technologies disclosed herein. Thus, the computer system 700 can provide, in some embodiments, one or more functions illustrated and described herein with regard to the user device 102, the server computer 116, the contact device 120, the data store 124, the geodata database 128, the other device 130, and/or the third party device 132. The computer system 700 includes a processing unit 702, a memory 704, one or more user interface devices 706, one or more input/output (“I/O”) devices 708, and one or more network devices 710, each of which is operatively connected to a system bus 712. The system bus 712 can enable bi-directional communication between the processing unit 702, the memory 704, the user interface devices 706, the I/O devices 708, and the network devices 710.

The processing unit 702 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 704 communicates with the processing unit 702 via the system bus 712. In some embodiments, the memory 704 is operatively connected to a memory controller (not shown) that enables communication with the processing unit 702 via the system bus 712. The memory 704 includes an operating system 714 and one or more program modules 716. The operating system 714 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or SONOMA families of operating systems from APPLE CORPORATION, the FREEBSD family of operating systems, the SOLARIS family of operating systems from ORACLE CORPORATION, other operating systems, and the like.

The program modules 716 may include various software and/or program modules described herein. In some embodiments, for example, the program modules 716 can include the coverage management application 108 and/or the coverage management service 114. These and/or other programs can be embodied in computer-readable media containing instructions that, when executed by the processing unit 702, perform one or more of the methods 200, 300, and 400 described in detail above with respect to FIGS. 2-4 and/or other functionality as illustrated and described herein. It can be appreciated that, at least by virtue of the instructions embodying the methods 200, 300, 400, and/or other functionality illustrated and described herein being stored in the memory 704 and/or accessed and/or executed by the processing unit 702, the computer system 700 is a special-purpose computing system that can facilitate providing the functionality illustrated and described herein. According to embodiments, the program modules 716 may be embodied in hardware, software, firmware, or any combination thereof. Although not shown in FIG. 7, it should be understood that the memory 704 also can be configured to store the device data 118, the user database 122, the geodata 126, the alert 134, the command 136, and/or other data, if desired.

By way of example, and not limitation, computer-readable media may include any available computer storage media or communication media that can be accessed by the computer system 700. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 700. In the claims, the phrase “computer storage medium” and variations thereof does not include waves or signals per se and/or communication media.

The user interface devices 706 may include one or more devices with which a user accesses the computer system 700. The user interface devices 706 may include, but are not limited to, computers, servers, personal digital assistants, cellular phones, or any suitable computing devices. The I/O devices 708 enable a user to interface with the program modules 716. In one embodiment, the I/O devices 708 are operatively connected to an I/O controller (not shown) that enables communication with the processing unit 702 via the system bus 712. The I/O devices 708 may include one or more input devices, such as, but not limited to, a keyboard, a mouse, or an electronic stylus. Further, the I/O devices 708 may include one or more output devices, such as, but not limited to, a display screen or a printer.

The network devices 710 enable the computer system 700 to communicate with other networks or remote systems via a network, such as the network 104. Examples of the network devices 710 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such as a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

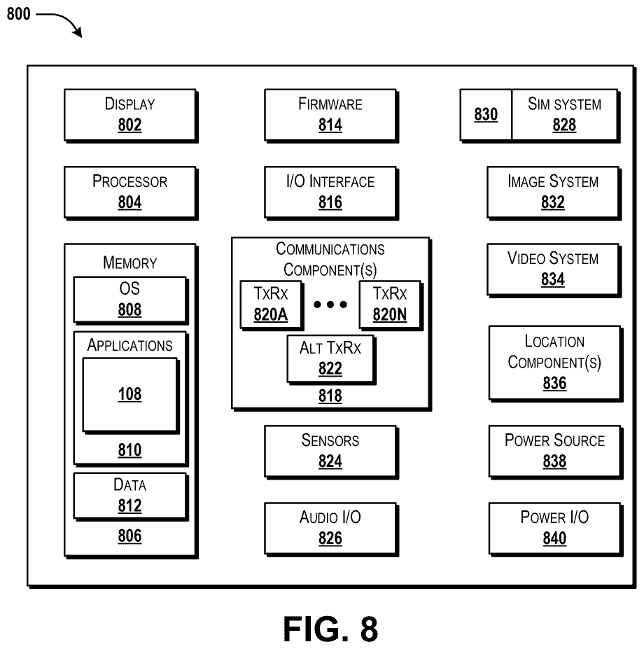

Turning now to FIG. 8, an illustrative mobile device 800 and components thereof will be described. In some embodiments, the user device 102, the contact device 120, the other device 130, and/or the third party device 132 described above with reference to FIGS. 1-5B can be configured as and/or can have an architecture similar or identical to the mobile device 800 described herein in FIG. 8. It should be understood, however, that the user device 102, the contact device 120, the other device 130, and/or the third party device 132 may or may not include the functionality described herein with reference to FIG. 8. While connections are not shown between the various components illustrated in FIG. 8, it should be understood that some, none, or all of the components illustrated in FIG. 8 can be configured to interact with one another to carry out various device functions. In some embodiments, the components are arranged so as to communicate via one or more busses (not shown). Thus, it should be understood that FIG. 8 and the following description are intended to provide a general understanding of a suitable environment in which various aspects of embodiments can be implemented, and should not be construed as being limiting in any way.

As illustrated in FIG. 8, the mobile device 800 can include a display 802 for displaying data. According to various embodiments, the display 802 can be configured to display various graphical user interface (“GUI”) elements such as, for example, elements for indicating one or more active or available network connections, time until a network connection will be available, costs for using a network connection, limitations of a network connection, a status of network connection (e.g., active, inactive, available, unavailable, primary, secondary, etc.), text, images, video, virtual keypads and/or keyboards, messaging data, notification messages, metadata, internet content, device status, time, date, calendar data, device preferences, map and location data, combinations thereof, and/or the like. The mobile device 800 also can include a processor 804 and a memory or other data storage device (“memory”) 806. The processor 804 can be configured to process data and/or can execute computer-executable instructions stored in the memory 806. The computer-executable instructions executed by the processor 804 can include, for example, an operating system 808, one or more applications 810 such as the coverage management application 108 and/or the coverage management service 114, other computer-executable instructions stored in a memory 806, or the like. In some embodiments, the applications 810 also can include a UI application (not illustrated in FIG. 8).

The UI application can interface with the operating system 808, such as the operating system 106 shown in FIG. 1, to facilitate user interaction with functionality and/or data stored at the mobile device 800 and/or stored elsewhere. In some embodiments, the operating system 808 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 804 to aid a user in entering content, providing network connection status and details, configuring settings, manipulating address book content and/or settings, multimode interaction, interacting with other applications 810, and otherwise facilitating user interaction with the operating system 808, the applications 810, and/or other types or instances of data 812 that can be stored at the mobile device 800. The data 812 can include, for example, the coverage management application 108, the coverage management service 114, and/or other applications or program modules. According to various embodiments, the data 812 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 810, the data 812, and/or portions thereof can be stored in the memory 806 and/or in a firmware 814, and can be executed by the processor 804.

It can be appreciated that, at least by virtue of storage of the instructions corresponding to the applications 810 and/or other instructions embodying other functionality illustrated and described herein in the memory 806, and/or by virtue of the instructions corresponding to the applications 810 and/or other instructions embodying other functionality illustrated and described herein being accessed and/or executed by the processor 804, the mobile device 800 is a special-purpose mobile device that can facilitate providing the functionality illustrated and described herein. The firmware 814 also can store code for execution during device power up and power down operations. It can be appreciated that the firmware 814 can be stored in a volatile or non-volatile data storage device including, but not limited to, the memory 806 and/or a portion thereof.

The mobile device 800 also can include an input/output (“I/O”) interface 816. The I/O interface 816 can be configured to support the input/output of data such as location information, history information, location information, contact information, identity data, contacts, preferences, device data 118, the user database 122, the geodata 126, the alert 134, the command 136, user information, organization information, presence status information, user IDs, passwords, and application initiation (start-up) requests. In some embodiments, the I/O interface 816 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45 or RJ48) port, a telephone (RJ11 or the like) port, a proprietary port, combinations thereof, or the like. In some embodiments, the mobile device 800 can be configured to synchronize with another device to transfer content to and/or from the mobile device 800. In some embodiments, the mobile device 800 can be configured to receive updates to one or more of the applications 810 via the I/O interface 816, though this is not necessarily the case. In some embodiments, the I/O interface 816 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 816 may be used for communications between the mobile device 800 and a network device or local device.

The mobile device 800 also can include a communications component 818. The communications component 818 can be configured to interface with the processor 804 to facilitate wired and/or wireless communications with one or more networks such as the network 104, the direct-to-cell satellite network 110, the wireless network 112, and/or other networks described herein. In some embodiments, other networks include networks that utilize non-cellular wireless technologies such as WI-FI or WIMAX. In some embodiments, the communications component 818 includes a multimode communications subsystem for facilitating communications via the cellular network and one or more other networks.

The communications component 818, in some embodiments, includes one or more transceivers. The one or more transceivers, if included, can be configured to communicate over the same and/or different wireless technology standards with respect to one another. For example, in some embodiments one or more of the transceivers of the communications component 818 may be configured to communicate using GSM, CDMAONE, CDMA2000, LTE, and various other 2G, 2.5G, 3G, 4G, 5G, 6G, and greater generation technology standards. Moreover, the communications component 818 may facilitate communications over various channel access methods (which may or may not be used by the aforementioned standards) including, but not limited to, TDMA, FDMA, W-CDMA, OFDM, SDMA, and the like.

In addition, the communications component 818 may facilitate data communications using GPRS, EDGE, the HSPA protocol family including HSDPA, EUL or otherwise termed HSUPA, HSPA+, and various other current and future wireless data access standards. In the illustrated embodiment, the communications component 818 can include a first transceiver (“TxRx”) 820A that can operate in a first communications mode (e.g., GSM). The communications component 818 also can include an Nt^{h} transceiver (“TxRx”) 820N that can operate in a second communications mode relative to the first transceiver 820A (e.g., UMTS). While two transceivers 820A-N (hereinafter collectively and/or generically referred to as “transceivers 820”) are shown in FIG. 8, it should be appreciated that less than two, two, and/or more than two transceivers 820 can be included in the communications component 818.

The communications component 818 also can include an alternative transceiver (“Alt TxRx”) 822 for supporting other types and/or standards of communications. According to various contemplated embodiments, the alternative transceiver 822 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 818 also can facilitate reception from terrestrial radio networks, digital satellite radio networks, internet-based radio service networks, combinations thereof, and the like. The communications component 818 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 800 also can include one or more sensors 824. The sensors 824 can include temperature sensors, light sensors, air quality sensors, movement sensors, orientation sensors, noise sensors, proximity sensors, or the like. As such, it should be understood that the sensors 824 can include, but are not limited to, accelerometers, magnetometers, gyroscopes, infrared sensors, noise sensors, microphones, combinations thereof, or the like. Additionally, audio capabilities for the mobile device 800 may be provided by an audio I/O component 826. The audio I/O component 826 of the mobile device 800 can include one or more speakers for the output of audio signals, one or more microphones for the collection and/or input of audio signals, and/or other audio input and/or output devices.

The illustrated mobile device 800 also can include a subscriber identity module (“SIM”) system 828. The SIM system 828 can include a universal SIM (“USIM”), a universal integrated circuit card (“UICC”) and/or other identity devices. The SIM system 828 can include and/or can be connected to or inserted into an interface such as a slot interface 830. In some embodiments, the slot interface 830 can be configured to accept insertion of other identity cards or modules for accessing various types of networks. Additionally, or alternatively, the slot interface 830 can be configured to accept multiple subscriber identity cards. Because other devices and/or modules for identifying users and/or the mobile device 800 are contemplated, it should be understood that these embodiments are illustrative, and should not be construed as being limiting in any way.

The mobile device 800 also can include an image capture and processing system 832 (“image system”). The image system 832 can be configured to capture or otherwise obtain photos, videos, and/or other visual information. As such, the image system 832 can include cameras, lenses, charge-coupled devices (“CCDs”), combinations thereof, or the like. The mobile device 800 may also include a video system 834. The video system 834 can be configured to capture, process, record, modify, and/or store video content. Photos and videos obtained using the image system 832 and the video system 834, respectively, may be added as message content to an MMS message, email message, and sent to another mobile device. The video and/or photo content also can be shared with other devices via various types of data transfers via wired and/or wireless communication devices as described herein.

The mobile device 800 also can include one or more location components 836. The location components 836 can be configured to send and/or receive signals to determine a geographic location of the mobile device 800. According to various embodiments, the location components 836 can send and/or receive signals from global positioning system (“GPS”) devices, assisted-GPS (“A-GPS”) devices, WI-FI/WIMAX and/or cellular network triangulation data, combinations thereof, and the like. The location component 836 also can be configured to communicate with the communications component 818 to retrieve triangulation data for determining a location of the mobile device 800. In some embodiments, the location component 836 can interface with cellular network nodes, telephone lines, satellites, location transmitters and/or beacons, wireless network transmitters and receivers, combinations thereof, and the like. In some embodiments, the location component 836 can include and/or can communicate with one or more of the sensors 824 such as a compass, an accelerometer, and/or a gyroscope to determine the orientation of the mobile device 800. Using the location component 836, the mobile device 800 can generate and/or receive data to identify its geographic location, or to transmit data used by other devices to determine the location of the mobile device 800. The location component 836 may include multiple components for determining the location and/or orientation of the mobile device 800.

The illustrated mobile device 800 also can include a power source 838. The power source 838 can include one or more batteries, power supplies, power cells, and/or other power subsystems including alternating current (“AC”) and/or direct current (“DC”) power devices. The power source 838 also can interface with an external power system or charging equipment via a power I/O component 840. Because the mobile device 800 can include additional and/or alternative components, the above embodiment should be understood as being illustrative of one possible operating environment for various embodiments of the concepts and technologies described herein. The described embodiment of the mobile device 800 is illustrative, and should not be construed as being limiting in any way.

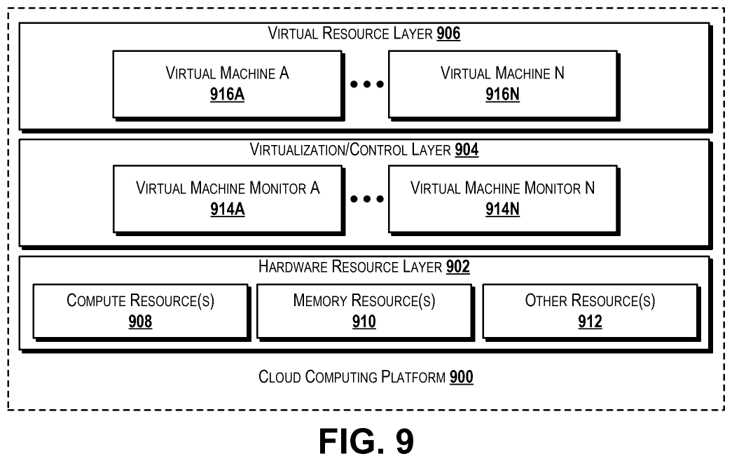

FIG. 9 illustrates an illustrative architecture for a cloud computing platform 900 that can be capable of executing the software components described herein for providing determining and using vulnerability scores during direct-to-cell satellite coverage and/or for interacting with the coverage management application 108 and/or the coverage management service 114. Thus, it can be appreciated that in some embodiments of the concepts and technologies disclosed herein, the cloud computing platform 900 illustrated in FIG. 9 can be used to provide the functionality described herein with respect to the user device 102, the server computer 116, the contact device 120, the data store 124, the geodata database 128, the other device 130, and/or the third party device 132.

The cloud computing platform 900 thus may be utilized to execute any aspects of the software components presented herein. Thus, according to various embodiments of the concepts and technologies disclosed herein, the coverage management application 108 and/or the coverage management service 114 can be implemented, at least in part, on or by elements included in the cloud computing platform 900 illustrated and described herein. Those skilled in the art will appreciate that the illustrated cloud computing platform 900 is a simplification of but only one possible implementation of an illustrative cloud computing platform, and as such, the illustrated cloud computing platform 900 should not be construed as being limiting in any way.

In the illustrated embodiment, the cloud computing platform 900 can include a hardware resource layer 902, a virtualization/control layer 904, and a virtual resource layer 906. These layers and/or other layers can be configured to cooperate with each other and/or other elements of a cloud computing platform 900 to perform operations as will be described in detail herein. While connections are shown between some of the components illustrated in FIG. 9, it should be understood that some, none, or all of the components illustrated in FIG. 9 can be configured to interact with one another to carry out various functions described herein. In some embodiments, the components are arranged so as to communicate via one or more networks such as, for example, the network 104 illustrated and described hereinabove (not shown in FIG. 9). Thus, it should be understood that FIG. 9 and the following description are intended to provide a general understanding of a suitable environment in which various aspects of embodiments can be implemented, and should not be construed as being limiting in any way.

The hardware resource layer 902 can provide hardware resources. In the illustrated embodiment, the hardware resources can include one or more compute resources 908, one or more memory resources 910, and one or more other resources 912. The compute resource(s) 908 can include one or more hardware components that can perform computations to process data, and/or to execute computer-executable instructions of one or more application programs, operating systems, services, and/or other software including, but not limited to, the coverage management application 108 and/or the coverage management service 114 illustrated and described herein.

According to various embodiments, the compute resources 908 can include one or more central processing units (“CPUs”). The CPUs can be configured with one or more processing cores. In some embodiments, the compute resources 908 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 908 can include one or more discrete GPUs. In some other embodiments, the compute resources 908 can include one or more CPU and/or GPU components that can be configured in accordance with a co-processing CPU/GPU computing model. Thus, it can be appreciated that in some embodiments of the compute resources 908, a sequential part of an application can execute on a CPU and a computationally-intensive part of the application can be accelerated by the GPU. It should be understood that this example is illustrative, and therefore should not be construed as being limiting in any way.

In some embodiments, the compute resources 908 also can include one or more system on a chip (“SoC”) components. It should be understood that an SoC component can operate in association with one or more other components as illustrated and described herein, for example, one or more of the memory resources 910 and/or one or more of the other resources 912. In some embodiments in which an SoC component is included, the compute resources 908 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Texas; one or more customized versions of any of the above SoCs; and/or one or more other brand and/or one or more proprietary SoCs.

The compute resources 908 can be or can include one or more hardware components arranged in accordance with an ARM architecture, available for license from ARM HOLDINGS of Cambridge, United Kingdom. Alternatively, the compute resources 908 can be or can include one or more hardware components arranged in accordance with an x86 architecture, such as an architecture available from INTEL CORPORATION of Mountain View, California, and others. Those skilled in the art will appreciate the implementation of the compute resources 908 can utilize various computation architectures and/or processing architectures. As such, the various example embodiments of the compute resources 908 as mentioned hereinabove should not be construed as being limiting in any way. Rather, implementations of embodiments of the concepts and technologies disclosed herein can be implemented using compute resources 908 having any of the particular computation architecture and/or combination of computation architectures mentioned herein as well as other architectures.

Although not separately illustrated in FIG. 9, it should be understood that the compute resources 908 illustrated and described herein can host and/or execute various services, applications, portals, and/or other functionality illustrated and described herein. Thus, the compute resources 908 can host and/or can execute the coverage management application 108, the coverage management service 114, and/or other applications or services illustrated and described herein.

The memory resource(s) 910 can include one or more hardware components that can perform or provide storage operations, including temporary and/or permanent storage operations. In some embodiments, the memory resource(s) 910 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 908, subject to the definition of “computer storage media” provided above (e.g., as excluding waves and signals per se and/or communication media as defined in this application).

Although not illustrated in FIG. 9, it should be understood that the memory resources 910 can host or store the various data illustrated and described herein including, but not limited to, device data 118, the user database 122, the geodata 126, the alert 134, the command 136, and/or other data, if desired. It should be understood that this example is illustrative, and therefore should not be construed as being limiting in any way. The other resource(s) 912 can include any other hardware resources that can be utilized by the compute resources(s) 908 and/or the memory resource(s) 910 to perform operations. The other resource(s) 912 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 902 can be virtualized by one or more virtual machine monitors (“VMMs”) 914A-914N (also known as “hypervisors;” hereinafter “VMMs 914”). The VMMs 914 can operate within the virtualization/control layer 904 to manage one or more virtual resources that can reside in the virtual resource layer 906. The VMMs 914 can be or can include software, firmware, and/or hardware that alone or in combination with other software, firmware, and/or hardware, can manage one or more virtual resources operating within the virtual resource layer 906.

The virtual resources operating within the virtual resource layer 906 can include abstractions of at least a portion of the compute resources 908, the memory resources 910, the other resources 912, or any combination thereof. These abstractions are referred to herein as virtual machines (“VMs”). In the illustrated embodiment, the virtual resource layer 906 includes VMs 916A-916N (hereinafter “VMs 916”).

Based on the foregoing, it should be appreciated that systems and methods for providing determining and using vulnerability scores during direct-to-cell satellite coverage have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising:
obtaining device data associated with a user device, wherein the device data comprises identity data that identifies the user device, connection data that identifies a current network connection of the user device, and location data that indicates a current location of the user device, wherein the connection data indicates that the user device currently has limited network connectivity and is connected to a direct-to-cell satellite network connection;
calculating, based on the connection data and the location data, a vulnerability score for the user device, wherein the vulnerability score defines a level of vulnerability of a user of the user device at the current location of the user device;
obtaining a record associated with the user device, where the record is stored in a user database;
updating the record with the vulnerability score, the current network connection of the user device, and the current location of the user device, wherein an updated record identifies a contact that is to be updated if the vulnerability score indicates a high vulnerability for the user device when the user device has the limited network connectivity and is connected to the direct-to-cell satellite network connection;
determining, based on the record associated with the user device, if the vulnerability score is actionable; and
in response to determining that the vulnerability score is actionable, generating an alert for the contact.

2. The system of claim 1, wherein the device data further comprises historical usage data, wherein the vulnerability score is calculated based on the connection data, the location data, and the historical usage data, and wherein the historical usage data and the location data are analyzed to determine a familiarity of the user of the user device with the current location of the user device.

3. The system of claim 1, wherein the device data further comprises contact information, and wherein the alert that is generated for the contact includes an indication that the user device is in a high vulnerability situation and data identifying the current location of the user device.

4. The system of claim 1, wherein the computer-executable instructions, when executed by the processor, cause the processor to perform operations further comprising:
generating a further alert for the user device, wherein the further alert comprises instructions for reducing the vulnerability score associated with the user device, wherein the instructions comprise instructions for navigating to a new location, and wherein the user device updates a user interface at the user device based on the further alert.

5. The system of claim 4, wherein the new location comprises a further geographic location at which the user device connects to a network connection other than the direct-to-cell satellite network connection, at which emergency services respond quicker than at the current location of the user device, and at which the user device has operated more frequently than at the current location of the user device.

6. The system of claim 1, wherein the computer-executable instructions, when executed by the processor, cause the processor to perform operations further comprising:
determining, based on the vulnerability score, that communications associated with the user device should be prioritized by a direct-to-cell satellite network;
generating a command that, when received by a device operating on the direct-to-cell satellite network, causes the direct-to-cell satellite network to prioritize the communications associated with the user device; and
sending, to the device operating on the direct-to-cell satellite network, the command.

7. The system of claim 1, wherein the computer-executable instructions, when executed by the processor, cause the processor to perform operations further comprising:
in response to determining, based on the vulnerability score and the record, that third party access to the record is to be enabled, enabling access to the record associated with the user device by a third party device, wherein the third party device comprises a computer device associated with an emergency responder.

8. A method comprising:
obtaining, at a server computer comprising a processor, device data associated with a user device, wherein the device data comprises identity data that identifies the user device, connection data that identifies a current network connection of the user device, and location data that indicates a current location of the user device, wherein the connection data indicates that the user device currently has limited network connectivity and is connected to a direct-to-cell satellite network connection;
calculating, by the processor and based on the connection data and the location data, a vulnerability score for the user device, wherein the vulnerability score defines a level of vulnerability of a user of a user device at the current location of the user device;
obtaining, by the processor, a record associated with the user device, where the record is stored in a user database;
updating, by the processor, the record with the vulnerability score, the current network connection of the user device, and the current location of the user device, wherein an updated record identifies a contact that is to be updated if the vulnerability score indicates a high vulnerability for the user device when the user device has the limited network connectivity and is connected to the direct-to-cell satellite network connection;
determining, by the processor and based on the record associated with the user device, if the vulnerability score is actionable; and
in response to determining that the vulnerability score is actionable, generating, by the processor, an alert for the contact.

9. The method of claim 8, wherein the device data further comprises historical usage data, wherein the vulnerability score is calculated based on the connection data, the location data, and the historical usage data, and wherein the historical usage data and the location data are analyzed to determine a familiarity of the user of the user device with the current location of the user device.

10. The method of claim 8, wherein the device data further comprises contact information, and wherein the alert that is generated for the contact includes an indication that the user device is in a high vulnerability situation and data identifying the current location of the user device.

11. The method of claim 8, further comprising:
generating a further alert for the user device, wherein the further alert comprises instructions for reducing the vulnerability score associated with the user device, wherein the instructions comprise instructions for navigating to a new location, and wherein the user device updates a user interface at the user device based on the further alert.

12. The method of claim 11, wherein the new location comprises a further geographic location at which the user device connects to a network connection other than the direct-to-cell satellite network connection, at which emergency services respond quicker than at the current location of the user device, and at which the user device has operated more frequently than at the current location of the user device.

13. The method of claim 8, further comprising:
determining, based on the vulnerability score, that communications associated with the user device should be prioritized by a direct-to-cell satellite network;
generating a command that, when received by a device operating on the direct-to-cell satellite network, causes the direct-to-cell satellite network to prioritize the communications associated with the user device; and
sending, to the device operating on the direct-to-cell satellite network, the command.

14. A computer storage medium having computer-executable instructions stored thereon that, when executed by a processor, cause the processor to perform operations comprising:
obtaining device data associated with a user device, wherein the device data comprises identity data that identifies the user device, connection data that identifies a current network connection of the user device, and location data that indicates a current location of the user device, wherein the connection data indicates that the user device currently has limited network connectivity and is connected to a direct-to-cell satellite network connection;
calculating, based on the connection data and the location data, a vulnerability score for the user device, wherein the vulnerability score defines a level of vulnerability of a user of a user device at the current location of the user device;
obtaining a record associated with the user device, where the record is stored in a user database;
updating the record with the vulnerability score, the current network connection of the user device, and the current location of the user device, wherein an updated record identifies a contact that is to be updated if the vulnerability score indicates a high vulnerability for the user device when the user device has the limited network connectivity and is connected to the direct-to-cell satellite network connection;
determining, based on the record associated with the user device, if the vulnerability score is actionable; and
in response to determining that the vulnerability score is actionable, generating an alert for the contact.

15. The computer storage medium of claim 14, wherein the device data further comprises historical usage data, wherein the vulnerability score is calculated based on the connection data, the location data, and the historical usage data, and wherein the historical usage data and the location data are analyzed to determine a familiarity of the user of the user device with the current location of the user device.

16. The computer storage medium of claim 14, wherein the device data further comprises contact information, and wherein the alert that is generated for the contact includes an indication that the user device is in a high vulnerability situation and data identifying the current location of the user device.

17. The computer storage medium of claim 14, wherein the computer-executable instructions, when executed by the processor, cause the processor to perform operations further comprising:
generating a further alert for the user device, wherein the further alert comprises instructions for reducing the vulnerability score associated with the user device, wherein the instructions comprise instructions for navigating to a new location, and wherein the user device updates a user interface at the user device based on the further alert.

18. The computer storage medium of claim 17, wherein the new location comprises a further geographic location at which the user device connects to a network connection other than the direct-to-cell satellite network connection, at which emergency services respond quicker than at the current location of the user device, and at which the user device has operated more frequently than at the current location of the user device.

19. The computer storage medium of claim 14, wherein the computer-executable instructions, when executed by the processor, cause the processor to perform operations further comprising:
determining, based on the vulnerability score, that communications associated with the user device should be prioritized by a direct-to-cell satellite network;
generating a command that, when received by a device operating on the direct-to-cell satellite network, causes the direct-to-cell satellite network to prioritize the communications associated with the user device; and
sending, to the device operating on the direct-to-cell satellite network, the command.

20. The computer storage medium of claim 14, wherein the computer-executable instructions, when executed by the processor, cause the processor to perform operations further comprising:
in response to determining, based on the vulnerability score and the record, that third party access to the record is to be enabled, enabling access to the record associated with the user device by a third party device, wherein the third party device comprises a computer device associated with an emergency responder.
